(19) United States
(12) Patent Application Publication
(10) Pub. No.: US 2013/0310955 A1
(43) Pub. Date: Nov. 21, 2013

(54) Transformation and Dispensing of Consumables and Cosmetic Substances

(71) Applicant: Eugenio Minvielle, Rye, NY (US)

(72) Inventor: Eugenio Minvielle, Rye, NY (US)

(21) Appl. No.: 13/948,071

(22) Filed: Jul. 22, 2013

Related U.S. Application Data
(63) Continuation-in-part of application No. 13/937,167, filed on Jul. 8, 2013.
Application No. 13/937,167 is a continuation-in-part of application No. 13/732,050, filed on Dec. 31, 2012.
Application No. 13/732,050 is a continuation-in-part of application No. 13/485,878, filed on May 31, 2012.
(60) Provisional application No. 61/624,800, filed on Apr. 16, 2012.
(60) Provisional application No. 61/624,980, filed on Apr. 16, 2012.
(60) Provisional application No. 61/624,989, filed on Apr. 16, 2012.

(51) Int. Cl. G05B 13/02

(52) U.S. Cl. CPC G05B 13/02
USPC 700/28; 700/231

(57) ABSTRACT

Consumables and cosmetic substance systems and methods are disclosed enabling the tracking and communication of changes in efficacy values of consumables and cosmetic substances, and further enabling the adaptive transformation and dispensing of consumables and cosmetic substances.

### RELATED PATENT APPLICATIONS

This application is continuation-in-part of Utility application U.S. Ser. No. 13/937,167 filed Jul. 8, 2013, titled “CONSUMER INFORMATION AND SENSING SYSTEM FOR NUTRITIONAL SUBSTANCES,” which is a continuation-in-part of Utility application U.S. Ser. No. 13/732,050 filed Dec. 31, 2012, which is a continuation-in-part of Utility application U.S. Ser. No. 13/485,878 filed May 31, 2012, which claims priority to U.S. Provisional Patent Application Ser. No. 61/624,800, filed Apr. 16, 2012; U.S. Provisional Patent Application Ser. No. 61/624,980, filed Apr. 16, 2012; and U.S. Provisional Patent Application, 61/624,989, filed Apr. 16, 2012, the contents of which are all incorporated herein by reference in their entirety.

### FIELD OF THE INVENTION

The present inventions relate to adaptive transformation and dispensing of consumables and cosmetic substances in conjunction with the collection, transmission, and use of information regarding a current efficacy value of the consumables and cosmetic substance.

### BACKGROUND OF THE INVENTION

Consumables and cosmetic substances comprise a wide array of products that are used by consumers to enhance their health, quality of life, hygiene, scent, appearance, and so forth. Consumables and cosmetic substances and their ingredients may be grown (plants), raised (animals) or synthesized (synthetic compounds), or transformed from any combination of consumables and cosmetic ingredients. Additionally, consumables and cosmetic substances can be sourced from, or found in a wild, non-cultivated form, which can be caught or collected. While the collectors and creators of consumables and cosmetic substances generally obtain and/or generate information about the source, history, and active ingredient content of their products, they generally do not pass such information along to the users of their products. One reason is that the participant groups in the consumables and cosmetic substance industry have tended to act like “silo” industries. Each group in the consumables and cosmetic substance industry: growers, collectors, packagers, processors, distributors, retailers, and compounders work separately, and either shares little to no information between themselves. There is generally no consumer access to, and little traceability of, information regarding the creation and/or origin, preservation, processing, preparation, dispensing, or local storage of consumables and cosmetic substances. Further, there is no information available to consumers as to the evolution of a consumables and cosmetic substance's efficacy. Such evolution in efficacy is typically a degradation, but could be a maintenance or improvement. It would be desirable for such information be available to the consumers of consumables and cosmetic substances, as well as all participants in the consumables and cosmetic industry—the consumables and cosmetic substance supply system.

While the consumables and cosmetic substances supply system has endeavored to increase the efficacy value of the consumables and cosmetic substances it produces, it has not provided a means of tracking the evolution of consumables and cosmetic substances efficacy value in a manner that makes information regarding the evolution available, useful, or responsive to consumers. The efficacy value of consumables and cosmetic substances refers to the portion of these consumables and cosmetic substances which are beneficial to the organisms which use them. Examples of the efficacy value of consumables and cosmetic substances could include: particular Aloe vera derived phytochemical concentrations in skin lotion; antibiotic concentration in antibiotic ointment; percent by weight of Naproxen in a pain pill; concentration of Omega oil in a dietary supplement; concentration of tea tree oil in a shampoo; concentration of tetrahydrozoline hydrochloride in eye drops; Vitamin C level in a vitamin pill; specific amino-acid protein levels in lip stick; amount of epinephrine in an emergency epinephrine injector; the concentration of Hydrogen Peroxide in a bottle of antiseptic; and an amount or concentration of any other component which is necessary, or at least beneficial, to the organism using the consumables and cosmetic substances.

While there has recently been greater attention by consumer organizations, health organizations and the public to the efficacy value of consumables and cosmetic substances, the consumables and cosmetic substance industry has been slow in responding to this attention. One reason for this may be that since the consumables and cosmetic substance industry operates as silos of those who create consumables and cosmetic substances, those who preserve and transport consumables and cosmetic substances, those who transform consumables and cosmetic substances, and those who finally prepare the consumables and cosmetic substances for use by the consumer, there has been no system wide coordination or management of efficacy value, and no practical way for creators, preservers, transformers, dispensers, and consumers to update labeling content for consumables and cosmetic substances. While each of these silo industries may be able to maintain or increase the efficacy value of the consumables and cosmetic substances they handle, each silo industry has only limited information and control of the consumables and cosmetic substances they receive, and the consumables and cosmetic substances they pass along, and the limited information in their control provides little utility beyond tracking product inventory and predetermined expiration dates.

As consumers better understand their need for consumables and cosmetic substances with higher efficacy value, they will start demanding that the consumables and cosmetic substance industry offer products which include higher efficacy value, and/or at least information regarding efficacy value of such products, as well as information regarding the source, creation and other origin information for the consumables and cosmetic substance. As societies and governments seek to improve their constituents' health and lower healthcare costs, incentives and/or mandates will be given to the consumables and cosmetic substance industry to track, maintain, and/or increase the efficacy value of consumables and cosmetic substances they handle. There will be a need, not only within each consumables and cosmetic substance industry silo to maintain or improve the efficacy value of their products, but an industry-wide solution to allow the management and tracking of evolving efficacy values across the entire cycle from creation to use. In order to manage the efficacy value of consumables and cosmetic substances across the entire cycle from creation to use, the consumables and cosmetic substance industry will need to identify, track, measure, estimate, preserve, transform, condition, and record efficacy value for consumables and cosmetic substances. Of particular importance is the measurement, estimation, and tracking of changes to the efficacy content of a consumables and cosmetic substance from creation to use. This information could be used, not only by the consumer in selecting and dispensing particular consumables and cosmetic substances, but could be used by the other consumables and cosmetic substance industry silos, including creation, preservation, transformation, and dispensing, to make decisions on how to create, handle and process consumables and cosmetic substances. Additionally, those who sell consumables and cosmetic substances to consumers could communicate perceived qualitative values of the consumables and cosmetic substance in their efforts to market and position their consumables and cosmetic substance products. Further, a determinant of price of the consumables and cosmetic substance could be particular efficacy values, and if changes to those values are perceived as desirable. For example, if a desirable efficacy value has been maintained, improved, or minimally degraded, the corresponding consumables and cosmetic substance could be marketed as a premium product. Still further, a system allowing creators, preservers, transformers, and applicators of consumables and cosmetic substances to update labeling content to reflect the most current information about the consumables and cosmetic substances would provide consumers with the information they need to make informed decisions regarding the consumables and cosmetic substances they purchase and use. Such information updates could include efficacy values of the consumables and cosmetic substance, and may further include information regarding the source, creation and other origin information for the consumables and cosmetic substance.

For example, the grower of Aloe vera generally only provides basic information such as the variety and grade of its Aloe vera leafs to an Aloe vera transformer, who extracts juices from the Aloe vera leafs, concentrates the extract, and preserves and ships the concentrate to another transformer, a skin lotion transformer, for use as an ingredient in skin lotion. The Aloe vera transformer may only tell the skin lotion transformer that the Aloe vera extract has been concentrated and frozen after extraction. The skin lotion transformer may only provide the consumer with rudimentary instructions of how to apply the skin lotion and only tell the consumer that the skin lotion contains Aloe vera extract among its ingredients. Finally, the consumer of the skin lotion will likely keep her opinions on the quality of the skin lotion to herself, unless it was an especially bad experience, where she might contact the skin lotion transformer's customer support program to complain. Very minimal, or no, information on the efficacy content of the skin lotion related to the Aloe vera extract is passed along to the consumer. The consumer knows essentially nothing about changes (generally a degradation, but could be a maintenance or even an improvement) to the efficacy content of the skin lotion related to the Aloe vera extract, particularly related to Aloe vera derived phytochemical concentrations in the skin lotion, which have occurred from creation, transformation, preservation, local storage, or dispensing. The consumer is even more unlikely to be aware of possible changes to labeling content that a creator, preserver, or transformer may just have become be aware of, such as changes in information about efficacy values of the skin lotion or changes in information regarding the source, creation and other origin information about the skin lotion or its ingredients. If communicated, such changes to labeling content could affect the purchase, local storage, dispensing, and use of the skin lotion. Further, if communicated, such changes to labeling content could affect the health, safety, and wellbeing of the consumer. It is also clear that such changes would best be communicated rapidly and by a means readily utilized by the consumer.

Consumers' needs are changing as consumers are demanding more of consumables and cosmetic substances. Consumers are also asking for more information about the consumables and cosmetic substances they consume, such as specific characteristics' relating not only to efficacy values, but to allergens, irritants, substitutions, and adulteration. For example, consumables and cosmetic substances which contain latex, dyes, ingredients derived from particular animal or plant sources, preservatives, hormones or hormones, antibiotics, etc. need to be avoided by certain consumers. However, the transformer of the skin lotion, in the prior example, has very little information to share other than possibly the source of the ingredients of the skin lotion and its processing steps in manufacturing the skin lotion. The transformer of the skin lotion does not know the efficacy value of the product after it has been locally stored and is ready for dispensing by the consumer, cannot predict changes to the efficacy value, and cannot inform a consumer of this information to enable the consumer to better meet their needs. For example, the consumer of the skin lotion may want to know what changes have occurred to efficacy values related to particular phytochemicals derived from Aloe vera, and what residual efficacy values remain, when it is purchased, during local storage in her house, and upon dispensing. Such changes in efficacy values are usually a degradation, but could be a maintenance or even improvement. There is a need to preserve, measure, estimate, store and/or transmit information regarding such efficacy values, including changes to these values, throughout the consumables and cosmetic substance supply system. Additionally, given the opportunity and a system capable of receiving and processing real time consumer feedback and updates regarding changes in the efficacy value of consumables and cosmetic substances, consumers can even play a role in updating dynamic information about the consumables and cosmetic substances they have purchased and/or are prepared to consume, such that the information is available and useful to others in the consumables and cosmetic substance supply system. Ideally, equipment and environments for local storage of consumables and cosmetic substances by consumers, such as any storage location, medicine cabinet, portable container, tray, bag, and so forth, could interact with consumables and cosmetic substance to provide such consumer feedback and updates, and preferably are utilized to meet the particular consumer's needs.

The efficacy value information for consumables and cosmetic substances provided to consumers is often minimal. When efficacy value information is provided, it is static in nature, and most likely to reflect an initial efficacy value of the corresponding consumables and cosmetic substance. There is a need to provide information about consumables and cosmetic substances in a meaningful manner. Such information needs to be presented in a manner that is responsive to the specific needs of a particular consumer. For example, consumers with a medical condition, such as diabetes, would want to track specific information regarding efficacy values associated with Insulin medicaments they purchase, locally store, and dispense, and would benefit further from knowing changes in the efficacy values or having tools to quickly indicate or estimate these changes in a retrospective, current, or prospective fashion, and even tools to report these changes, or impressions of these changes, in a real-time fashion. Consumers would want to track specific efficacy values of consumables and cosmetic substances to be aware of changes in their efficacy values, particularly a degradation in efficacy values, and for potential interactions with other consumables and cosmetic substances they are consuming or plan to consume or consumables and cosmetic substances they are consuming or plan to consume.

In fact, each silo in the consumables and cosmetic substance industry already creates and tracks some information, including efficacy value information, about their product internally. For example, the framer who grew the Aloe vera leafs knows the variety of plant, condition of the soil, the source of the water, the fertilizers and pesticides used, and can measure the leafs' efficacy content at creation. The Aloe vera extract transformer knows when it was picked, how it was transported to his processing facility, how the Aloe vera leafs were preserved, the juice extracted, concentrated, frozen, and preserved before being sent to the skin lotion transformer, when it was delivered to the skin lotion transformer, and may know what degradation to efficacy value has occurred during extraction and concentration. The skin lotion transformer likely knows the source of each ingredient of the skin lotion, how it was processed, including the processing parameters followed at his processing facility, and how it was preserved and packaged for the consumer. Not only may the skin lotion transformer know what degradation to efficacy value occurred while processing the skin lotion, it may modify its processing and post-processing preservation to minimally affect the efficacy value. Finally, a consumer generally knows how she has locally stored the skin lotion after she has purchased it, how she used the skin lotion, and whether she did or did not enjoy it.

If there was a mechanism to share this information, the quality of consumables and cosmetic substances, including efficay values, could be preserved and improved. Consumers could be better informed about consumables and cosmetic substances they select and consume, including the state, and changes in the state, of the efficacy value of the consumables and cosmetic substance throughout its lifecycle from creation to consumption. The efficiency and cost effectiveness of consumables and cosmetic substances could also be improved. Feedback within the entire chain from creator to consumer could provide a closed-loop system that could improve overall quality, efficiency value, product value and profit. For example, in the pharmaceutical supply chain, much of the product is wasted due to safety margins included in static product expiration dates. The use of more accurate tracking information, measured quality information, including historical environmental information and efficacy value information could substantially reduce such waste. Collecting, preserving, measuring and/or tracking information about a consumables and cosmetic substance in the consumables and cosmetic substance supply system, would allow needed accountability. There would be nothing to hide.

As consumers are demanding more information about consumables and cosmetic substances they consume, they are asking for products that have higher efficacy value and would like consumables and cosmetic products to actually meet their specific requirements, particularly their needs regarding desired efficacy content of a dispensed consumables and cosmetic substance. While consumers, and all those who process, sell, and dispense consumables and cosmetic substances may obtain some information from current consumables and cosmetic substance tracking systems, such as labels, these current systems can provide only limited information.

Current packaging materials for consumables and cosmetic substances include plastics, paper, cardboard, glass, and synthetic materials. Generally, the packaging material is chosen by the manufacturer to best preserve the quality of the consumables and cosmetic substance until used by the customer. The packaging typically includes some information regarding the type of consumables and cosmetic substance, identity of the producer, country of origin, recommendations for use, expiration date, and warnings. Such packaging generally does not transmit or communicate source information of the consumables and cosmetic substance or its ingredients, such as creation information, current or historic information as to the external conditions of the packaged consumables and cosmetic substance, or current or historic information as to the internal conditions of the packaged consumables and cosmetic substance.

Traditional consumables and cosmetic substance manufacturers take consumables and cosmetic substance ingredients from creators, preservers, and other transformers and transform them into consumables and cosmetic substances for use by consumers. It is understood that in some cases, consumables and cosmetic substance transformers may pass consumables and cosmetic substances they have transformed on to other consumables and cosmetic substance transformers, or to those who dispense consumables and cosmetic substances to consumers, such as to compounding pharmacies, doctor's offices, and hospitals. While these consumables and cosmetic transformers have some knowledge of the consumables and cosmetic substance ingredients they purchase, and make such selections to meet the needs of the consumers of their products, they generally do not transmit that information along to the consumers, nor change the way they transform the consumables and cosmetic substances based on the history or current condition of the consumables and cosmetic substances they receive for transformation.

Consumers of consumables and cosmetic substances are typically provided with recommendations regarding the use of consumables and cosmetic substances they have obtained. Such recommendations may include, but are not limited to: usage quantity, such as, but not limited to, dosage, volume, or weight; how to take, apply, use, or otherwise consume; frequency of use; and so forth, and are referred to herein as dispensing parameters. Current dispensing parameters are static in nature, and based on assumed efficacy values of the corresponding consumables and cosmetic substance, typically the initial efficacy values of the corresponding consumables and cosmetic substance. However, the consumer has no way of knowing the history or current condition of the consumables and cosmetic substances they have obtained, particularly as it relates to efficacy values, at the time they obtain it, during the time it is locally stored by the consumer, or at the time it is dispensed for consumption. It is understood that as used herein, consumption of consumables and cosmetic substances refers to any end use or application of the consumables and cosmetic substances by a consumer, and may include, but is not limited to, ingestion, injection, inhalation, topical application, and any other known formats for use or end application. Further, consumers have no way to change the way they locally store, dispense and consume the consumables and cosmetic substances based on the history or current condition of the consumables and cosmetic substances.

An important issue in the creation, preservation, transformation, dispensing, and consumption of consumables and cosmetic substances are the changes that occur in consumables and cosmetic substances due to a variety of internal and external factors. Because consumables and cosmetic substances are composed of biological, organic, and/or chemical compounds, they are generally subject to degradation. This degradation generally reduces the efficacy values of consumables and cosmetic substances. While not always true, consumables and cosmetic substances have their highest efficacy content when they are created. Currently, the consumables and cosmetic substance industry attempts to minimize the loss of efficacy values, often through the use of additives or preservatives and often through storing the consumables and cosmetic substance at specific, often narrow, storage conditions, and/or attempts to hide the loss of efficacy values from consumers. Consumers are provided with virtually no tools to help them in their attempts to determine and minimize the loss of efficacy values of the consumables and cosmetic substances they acquire, locally store, dispense, and consume.

Overall, the examples herein of some prior or related systems and their associated limitations are intended to be illustrative and not exclusive. Other limitations of existing or prior systems will become apparent to those of skill in the art upon reading the following Detailed Description.

### OBJECTS OF THE INVENTION

In an object of the present invention, efficacy values of consumables and cosmetic substances are tracked, and changes, such as degradation, of the efficacy values is tracked and/or minimized, and information regarding the changes and information related to origin and creation of consumables and cosmetic substances, from creation through consumption, including all phases of preservation, transformation, local storage, dispensing, and consumption, is collected, stored, and transmitted.

In an object of the present invention, appliances and equipment are provided to track changes of efficacy values of consumables and cosmetic substances, and to minimize and/or track degradation of the efficacy values, and/or collect, store, and/or transmit information regarding the changes or degradation in the efficacy values, and information related to origin and creation of the consumables and cosmetic substance, during the local storage, dispensing, and consumption of the consumables and cosmetic substance.

In an object of the present invention, the local storage of consumables and cosmetic substances is modified or adapted to maintain and/or minimize degradation of and/or improve efficacy values of the consumables and cosmetic substances.

In an object of the present invention, information related to changes or degradation of efficacy values, including current efficacy values, or information related to the origin and creation of consumables and cosmetic substances, can be utilized during local storage and consumption of the consumables and cosmetic substances to confirm compliance, or non-compliance, with general consumer requirements, or with a specific consumer's requirements, regarding efficacy values, or regarding origin and creation of the consumables and cosmetic substances.

In an object of the present invention, information related to changes or degradation of a consumables and cosmetic substance's efficacy values, including current efficacy values, can be used to adaptively transform the consumables and cosmetic substance so as to maintain and/or minimize degradation of and/or improve the efficacy values of the adaptively transformed consumables and cosmetic substance.

In an object of the present invention, information related to changes or degradation of efficacy values, including current efficacy values, can be used to adaptively dispense a consumables and cosmetic substance for consumption so as to offset changes in the efficacy values of the consumables and cosmetic substance, such that the efficacy values of the dispensed consumables and cosmetic substance is optimized.

In an object of the present invention, sensors communicating with a consumables and cosmetic dispensing device can sense various physical attribute values of a consumables and cosmetic substance, and an identity of the consumables and cosmetic substance and a corresponding current efficacy value can thereafter be determined by comparing the sensed physical attribute values to a library of sensed physical attribute values for known consumables and cosmetic substances at known efficacy values, and further the consumables and cosmetic substance can be adaptively dispensed responsive to: its current efficacy value and consumer input received through a consumer interface of the dispensing device.

In an object of the present invention, sensors communicating with a smartphone can sense various physical attribute values of a consumables and cosmetic substance, and an identity of the consumables and cosmetic substance and a corresponding current efficacy value can thereafter be determined by comparing the sensed physical attribute values to a library of sensed physical attribute values for known consumables and cosmetic substances at known efficacy values, and further, an adaptive dispensing sequence can be determined for the consumables and cosmetic substance responsive to: its current efficacy value; and consumer input received through the smartphone.

### SUMMARY OF THE INVENTION

In an embodiment of the present invention, a system is provided for the tracking of changes of efficacy values of a consumables and cosmetic substance, wherein the system may collect, store, and transmit information regarding the changes of efficacy values of the consumables and cosmetic substance, and information related to origin and creation of the consumables and cosmetic substance, from creation through consumption, including all phases of preservation, transformation, dispensing, and consumption. As used herein, consumption of consumables and cosmetic substances refers to any end use or application of the consumables and cosmetic substances to a consumer, and may include, but is not limited to, ingestion, injection, inhalation, topical application, and any other known formats for use or end application.

In an embodiment of the present invention, a system is provided for the tracking of changes in efficacy values of a consumables and cosmetic substance, wherein the system may collect, store, and transmit information regarding the changes of efficacy values of the consumables and cosmetic substance, and information related to origin and creation of the consumables and cosmetic substance, during local storage of the consumables and cosmetic substance.

In an embodiment of the present invention, local storage devices and equipment are provided to track changes of efficacy values of a consumables and cosmetic substance, and to minimize and/or track degradation of said values, and/or collect, store, and/or transmit information regarding these changes or degradation, and information related to origin and creation of the consumables and cosmetic substance, during the local storage of the consumables and cosmetic substance prior to dispensing and consumption of the consumables and cosmetic substance.

In an embodiment of the present invention, preservation or local storage of a consumables and cosmetic substance is modified or adapted to maintain and/or minimize degradation of and/or improve efficacy values of the consumables and cosmetic substance.

In an embodiment of the present invention, information related to changes or degradation in efficacy values of a consumables and cosmetic substance, including current efficacy values, or information related to the origin and creation of the consumables and cosmetic substance, is compared with general consumer requirements, or with a specific consumer's requirements, to confirm compliance, or non-compliance, regarding efficacy values, or regarding origin and creation of the consumables and cosmetic substance.

In an embodiment of the present invention, information related to changes or degradation in efficacy values of a consumables and cosmetic substance, including current efficacy values, is used to determine adaptive dispensing parameters responsive to said changes or degradation in efficacy values, so as to offset said changes or degradation in efficacy values of the adaptively dispensed consumables and cosmetic substance.

In an embodiment of the present invention, sensors communicating with a consumables and cosmetic substance dispensing device sense various physical attribute values of a consumables and cosmetic substance, and determine an identity of the consumables and cosmetic substance and a corresponding current efficacy value by comparing the sensed physical attribute values to a library of sensed physical attribute values for known consumables and cosmetic substances at known efficacy values, and further can adaptively dispense, or communicate adaptive dispensing parameters, responsive to the consumables and cosmetic substance's current efficacy value and consumer input received through a consumer interface of the dispensing device.

In an embodiment of the present invention information regarding a change in a efficacy value of a consumables and cosmetic substance, referred to herein as ΔE, is: measured or collected or calculated or created or estimated or indicated or determined in any suitable manner; stored and/or tracked and/or transmitted and/or processed prior to transformation and/or following transformation, during preservation, during local storage, during dispensing, and during consumption, such that the degradation of the efficacy value can be minimized and residual efficacy value can be optimized. A change in efficacy value may not occur, in which case ΔE would be zero. The change of efficacy value may be a degradation, in which case ΔE would be negative. The change of efficacy value may be an improvement, in which case ΔE would be positive.

In an embodiment of the present invention, a system is provided for the creation, collection, storage, transmission, and/or processing of information regarding consumables and cosmetic substances so as to improve, maintain, or minimize degradation in efficacy values of the consumables and cosmetic substances. Additionally, the present invention provides such information for use by the creators, preservers, transformers, dispensers, and consumers of consumables and cosmetic substances. The consumables and cosmetic substance information creation, preservation, and transmission system of the present invention should allow the consumables and cosmetic substance supply system to improve its ability to minimize degradation in efficacy values of consumables and cosmetic substances, and/or inform the consumer about such degradation. The ultimate goal of the consumables and cosmetic substance supply system is to minimize degradation in efficacy values, or as it relates to ΔE, minimize the negative magnitude of ΔE. However, an interim goal should be providing consumers with significant information regarding any change, particularly degradation, in efficacy values of consumables and cosmetic substances consumers select, locally store, dispense, and consume, the ΔE, such that desired information regarding corresponding residual efficacy values can be ascertained using the ΔE. Entities within the consumables and cosmetic substance supply system who provide such ΔE information regarding consumables and cosmetic substances, particularly regarding degradation, will be able to differentiate their products from those who obscure and/or hide such information. Entities within the consumables and cosmetic substance supply system who provide local storage environments, local storage containers, and dispensing devices enabling the tracking and use of ΔE information will be able to differentiate their products from products that do not track and utilize ΔE information. Additionally, such entities should be able to charge a premium for products which either maintain their efficacy value, or supply more complete information about changes in their efficacy value, the ΔE.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a schematic functional block diagram of a consumables and cosmetic substance supply system relating to the present invention.

FIG. 2 shows a graph representing an efficacy value of a consumables and cosmetic substance which changes according to a change of condition for the consumables and cosmetic substance.

FIG. 3 shows a schematic functional block diagram of a transformation module according to the present invention.

FIG. 4 shows a schematic functional block diagram of a transformation module according to the present invention.

FIG. 5 shows a schematic functional block diagram of a transformation module according to the present invention.

FIG. 6 shows a schematic functional block diagram of a dispensing module according to the present invention.

FIG. 7 shows a schematic functional block diagram of a dispensing module according to the present invention.

FIG. 8 shows a schematic functional block diagram of a dispensing module according to the present invention.

FIG. 9 shows a graph representing an efficacy value of a consumables and cosmetic substance which changes according to changes in multiple conditions for the consumables and cosmetic substance.

FIG. 10 shows a graph representing an efficacy value of a consumables and cosmetic substance which changes according to changes in multiple conditions for the consumables and cosmetic substance.

FIG. 11 shows a schematic functional block diagram of a dispensing module according to the present invention.

FIGS. 12a and 12b show formats according to the present invention by which a ΔE, and related residual and initial efficacy values, may be expressed.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, WiFi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The modules in the systems can be understood to be integrated in some instances and in particular embodiments, only particular modules may be interconnected.

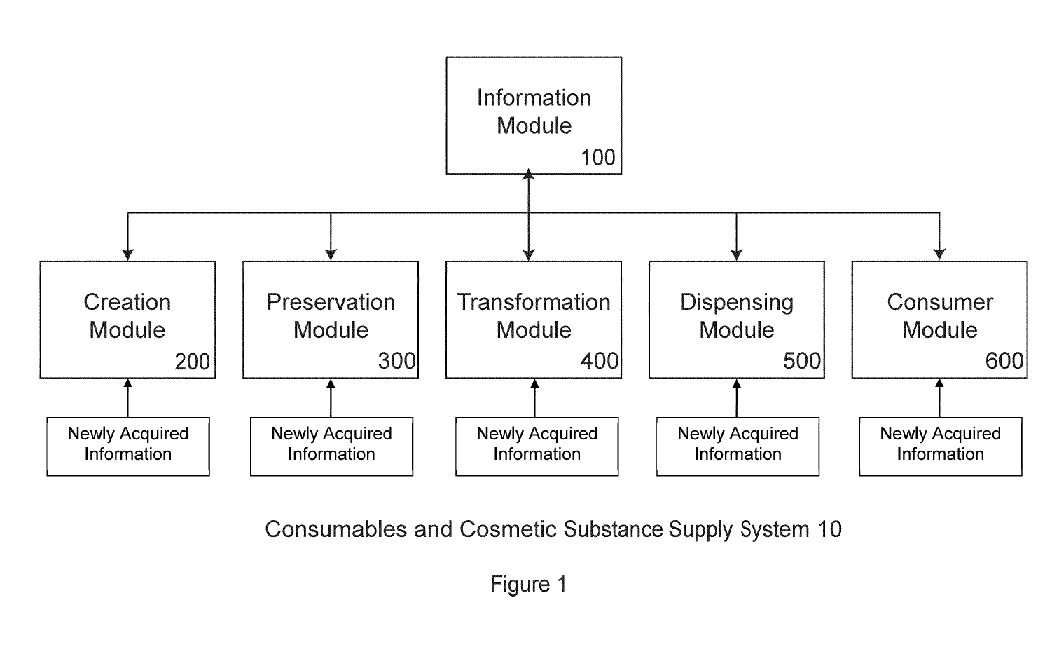

FIG. 1 shows the components of a consumables and cosmetic substance industry 10. It should be understood that this could be the consumables and cosmetic substance ecosystem for human consumption, but could also be the consumables and cosmetic substance industry for animal consumption, such as the veterinary medicine and animal grooming industries. A goal of the present invention for the consumables and cosmetic substance industry 10 is to create, preserve, transform and trace the change in efficacy values of consumables and cosmetic substances, collectively and individually also referred to herein as ΔE, through their creation, preservation, transformation, local storage, dispensing, and consumption. While the consumables and cosmetic substance industry 10 can be composed of many companies or businesses, it can also be integrated into combinations of business serving many roles, or can be one business or even individual. Since ΔE is a measure of the change in an efficacy value of a corresponding consumables and cosmetic substance, knowledge of a prior efficacy value (also referred to as prior efficacy state) of a consumables and cosmetic substance and the ΔE value will provide knowledge of the residual efficacy value (also referred to as current efficacy value or current efficacy state).

Module 200 is the creation module. This can be a system, organization, or individual which creates and/or originates consumables and cosmetic substances. Examples of this module include, but are not limited to, a farm that grows Aloe vera from which cosmetic products are made; a ranch that raises pigs from which porcine derived Insulin medicaments are made; an aquaculture farm that grows salmon from which Omega oil supplements are derived; a factory that synthesizes chemical compounds; a collector of wild Gen sing root; and so forth.

Preservation module 300, described in more detail in co-pending U.S. patent application Ser. No. ______ (attorney docket number 067465-109) filed herewith, titled “Preservation System for Consumables and Cosmetic Substances,” and incorporated by reference herein in its entirety, is a preservation system for storing, preserving and protecting the consumables and cosmetic substances created by creation module 200, or transformed by the transformation module 400. Once the consumables and cosmetic substance has been created or transformed, generally, it will need to be packaged in some manner for its transition to other modules in the consumables and cosmetic substances industry 10. While preservation module 300 is shown in a particular position in the consumables and cosmetic substance industry 10, following the creation module 200, it should be understood that the preservation module 300 actually can be placed anywhere consumables and cosmetic substances need to be stored and preserved during their transition from creation to consumption. It is understood that a consumables and cosmetic substance may experience more than one preservation event, and that such preservation events may even be considered to include the local storage of the consumables and cosmetic substance, such as in a local storage environment, a local storage container, or a dispenser prior to consumption.

A specific aspect of the present invention in achieving its goal related to ΔE information is to provide a system that tracks ΔE information during local storage or local preservation of a consumables and cosmetic substance by a consumer. It is understood that a consumables and cosmetic substance may experience more than one preservation event, and that such preservation events may include any known form of local storage or local preservation of a consumables and cosmetic substance prior to dispensing and consumption. Such local storage or local preservation is hereinafter referred to as local storage. Local storage may take many forms, such as the storage of refrigerated items in a refrigerator, the storage of frozen items in a freezer, the storage of medicine bottles in a pantry, the storage of cough syrup in a medicine cabinet, the storage of an emergency Epinephrine pen in a purse, and any other form of local storage of consumables and cosmetic substances known to those skilled in the art. It is understood that this includes the local storage of any consumables and cosmetic substance, for example, antibiotic suspensions stored in a refrigerator, skin lotion stored on a bathroom shelf, or pain pills stored in a purse, or any other consumables and cosmetic substance stored in known fashions.

Local storage may be enhanced by local storage environments provided with the same capabilities as the preservation module. In addition; local storage according to the present invention can be enabled by local storage containers, such as storage bags, trays, resealable storage-ware, jars, boxes, bottles, and any other type of storage environment, wherein the local storage container is provided with the same capabilities as the preservation module. In a further embodiment, currently known traditional formats for storage environments and storage containers are enabled to provide local storage of consumables and cosmetic substances by being coupled with a coupon, hereinafter referred to as a local storage coupon, wherein the local storage coupon provides a traditional storage environment or traditional storage container with the same capabilities as the preservation module. The local storage coupon can be attachment to, placed within, or in any known fashion coupled with, any known formats of traditional storage environments and traditional storage containers.

Transformation module 400 is a consumables and cosmetic substance processing system, such as a manufacturer who processes raw materials such as raw vitamin compounds and carriers into multi vitamin tablets. Transformation module 400 could also be an Aloe vera extract concentrate manufacturer who receives raw components, or ingredients, also referred to herein as component consumables and cosmetic substances, from preservation module 300 (for example Aloe vera leafs in a sealed, temperature controlled container) and processes them into an Aloe vera extract concentrate. While transformation module 400 is depicted as one module, it will be understood that consumables and cosmetic substances may be transformed by a number of transformation modules 400 on their path to consumption.

Dispensing module 500 is a module for dispensing consumables and cosmetic substances immediately before consumption. Dispensing module 500 may comprise, but is not limited to, a volumetric-based dispensing system, a weight-based dispensing machine, a counting device, a controlled storage environment, a storage container tracking storage conditions such as temperature, an individual such as a doctor, pharmacist, nurse, patient, etc. It may also be systems used by commercial establishments to prepare consumables and cosmetic substance for consumers, such as equipment used by a hospital or a compounding pharmacy, or other devices located at businesses which provide consumables and cosmetic substances to consumers. Such consumables and cosmetic substances could be for consumption at the business or for the consumer to take out from the business. Dispensing module 500 can also be any combination of these systems, machines, devices, equipment, or individuals used to dispense consumables and cosmetic substances for consumption by consumers.

Consumer module 600 collects information from the living entity which consumes the consumables and cosmetic substance which has passed through the various modules from creation to consumption. The consumer can be a human being, but could also be an animal, such as pets, zoo animals and livestock, which may themselves comprise consumables and cosmetic substances or nutritional substances for other consumption chains. Consumers could also be plant life which consumes consumables and cosmetic substances to grow, such as plants that are provided with chemical fertilizers or insecticides.

Information module 100 receives and transmits information regarding a consumables and cosmetic substance between each of the modules in the consumables and cosmetic substance industry 10 including, the creation module 200, the preservation module 300, the transformation module 400, the dispensing module 500, and the consumer module 600. The consumables and cosmetic substance information module 100 can be an interconnecting information transmission system which allows the transmission of information between various modules. Information module 100 contains a database, also referred to herein as a dynamic efficacy value database, where information regarding the consumables and cosmetic substance resides, particularly ΔE information for the consumables and cosmetic substance. Information module 100 may also contain a massive database of sensed physical attribute values for known consumables and cosmetic substances at known efficacy states, also referred to herein as a consumables and cosmetic substance attribute library, which can be utilized for determining the identity and current efficacy state of a consumables and cosmetic substance. Information module 100 can be connected to the other modules by a variety of communication systems, such as paper, computer networks, the internet and telecommunication systems, such as wireless telecommunication systems. In a system capable of receiving and processing real time consumer feedback and updates regarding changes in an efficacy value of a corresponding consumables and cosmetic substance, or ΔE, consumers can even play a role in updating the dynamic efficacy value database with observed or measured information about the consumables and cosmetic substances they have purchased and/or dispensed for consumption and/or consumed, so that the information is available and useful to determine a corresponding ΔE, and may further be available to others in the consumables and cosmetic substance supply system.

In an embodiment of the present invention, such consumer feedback and updates related to ΔE information are provided during the local storage of a consumables and cosmetic substance. In a preferred embodiment, such consumer feedback and updates related to ΔE information are obtained through, or provided by, local storage environments, local storage containers, local storage coupons, and dispensing appliances are useful in determining the ΔE and corresponding residual efficacy value of the consumables and cosmetic substance.

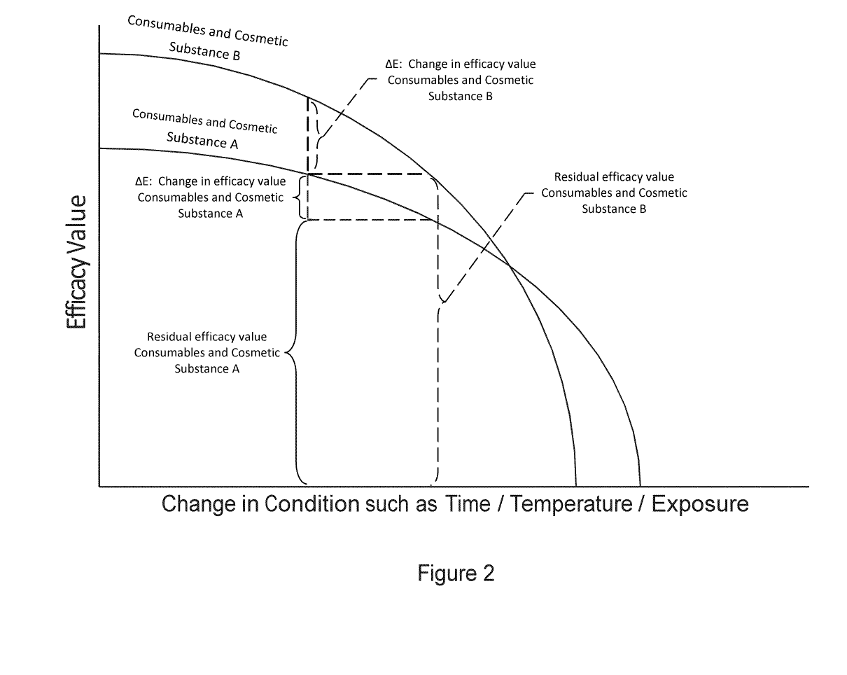

FIG. 2 is a graph showing the function of how an efficacy value of a consumables and cosmetic substance varies over the change in a condition of the consumables and cosmetic substance. Plotted on the vertical axis of this graph can be the efficacy value of a corresponding consumables and cosmetic substance. Plotted on the horizontal axis can be the change in condition of the consumables and cosmetic substance over a variable such as time, temperature, location, and/or exposure to environmental conditions. This exposure to environmental conditions can include: exposure to air, including the air pressure and partial pressures of oxygen, carbon dioxide, water, or ozone; airborne chemicals, pollutants, allergens, dust, smoke, carcinogens, radioactive isotopes, or combustion byproducts; exposure to moisture; exposure to energy such as mechanical impact, mechanical vibration, irradiation, heat, or sunlight; or exposure to materials such as packaging. The function plotted as consumables and cosmetic substance A could show a ΔE for skin lotion with Aloe vera, such as the degradation of an Aloe vera based phytochemical efficacy value over time. Any point on this curve can be compared to another point to measure and/or describe the change in efficacy value, or the ΔE, of consumables and cosmetic substance A. The function plotted as consumables and cosmetic substance B, also skin lotion with Aloe vera, shows the degradation in the same efficacy value, or the ΔE, of an Aloe vera based phytochemical efficacy value over time. Consumables and cosmetic substance B starts out with a higher efficacy value than consumables and cosmetic substance A, but degrades over time more quickly than consumables and cosmetic substance A.

In this example, where consumables and cosmetic substance A and consumables and cosmetic substance B are skin lotion with Aloe vera, this ΔE information regarding the degradation profile of efficacy value for each skin lotion could be used by the consumer in the selection and/or consumption of the corresponding skin lotion. If the consumer has this information at time zero when selecting a skin lotion product for purchase, the consumer could consider when she plans to consume the skin lotion and whether that is over a short time period or a long time period. For example, if the consumer planned to consume the skin lotion prior to the point when the curve represented by consumables and cosmetic substance B crosses the curve represented by consumables and cosmetic substance A, then the consumer should choose the skin lotion represented by consumables and cosmetic substance B because it has a higher efficacy value until it crosses the curve represented by consumables and cosmetic substance A. However, if the consumer expects to consume at least some of the skin lotion at a point in time after the time when the curve represented by consumables and cosmetic substance B crosses the curve represented by consumables and cosmetic substance A, then the consumer might choose to select the skin lotion represented by consumables and cosmetic substance A, even though the skin lotion represented by consumables and cosmetic substance A has a lower efficacy value than the skin lotion represented by consumables and cosmetic substance B at an earlier time. This change to a desired efficacy value in a consumables and cosmetic substance over a change in a condition of the consumables and cosmetic substance described in FIG. 2 can be measured and/or controlled throughout the consumables and cosmetic substance supply system 10. This example demonstrates how dynamically generated information regarding a ΔE of a consumables and cosmetic substance, in this case a change in efficacy value of skin lotion with Aloe vera, can be used to understand a rate at which that efficacy value changes or degrades; when that efficacy value expires; and a residual efficacy value of the consumables and cosmetic substance over a change in a condition of the consumables and cosmetic substance, in this example a change in time. This ΔE information could further be used to determine a best consumption date for consumables and cosmetic substance A and B, which could be different from each other depending upon the dynamically generated information generated for each. Still further, this ΔE information can be used to adaptively dispense the skin lotion such that the dispensed efficacy content meets the consumer's needs.

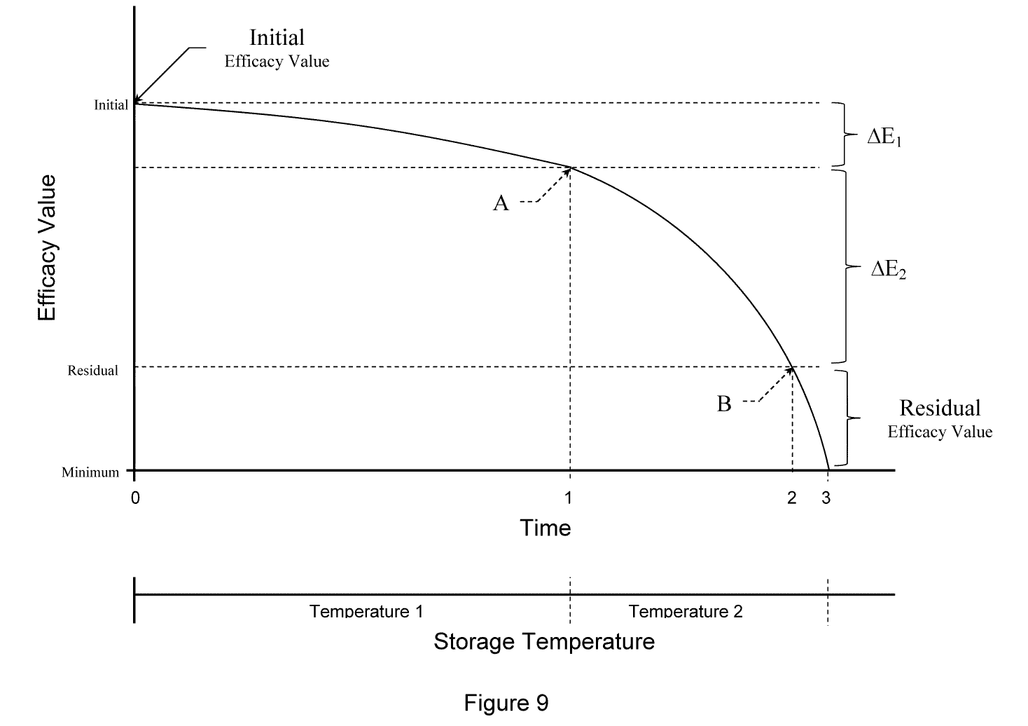

FIG. 9 is a graph showing the function of how an efficacy value of a consumables and cosmetic substance varies over a change in time and a change in a second condition, the storage temperature of the consumables and cosmetic substance. It is understood that change in time and change in storage temperature are offered by way of example, and are in no way limiting to the types of condition changes to which the present inventions may be applied. In this example, the change in an efficacy value of an antibiotic suspension, specifically, the change in its Penicillin concentration is shown over a period of time including its preservation at the pharmacy and a subsequent period of time including its local storage in a consumer's refrigerator. The graph shows that the antibiotic suspension is preserved at a first temperature, Temperature 1, for a first period of time indicated as 0 to 1, while at the pharmacy. The antibiotic suspension is purchased by a consumer at time 1, and subsequently stored at a second temperature, Temperature 2, for a second period of time indicated as 1 to 3, during local storage in the consumer's refrigerator, which is one example of a local storage environment as disclosed herein. It is noted that Temperature 2 is greater than Temperature 1, and accordingly the shape of the graph changes at point A when the antibiotic suspension is taken from Temperature 1 and stored at Temperature 2. As in the preservation module, the local storage environment can identify the antibiotic suspension stored within it by reading or scanning its dynamic information identifier, such as when it passes through a scanner provided in the refrigerator door, or alternatively by the consumer entering its dynamic information identifier via a consumer interface provided on the refrigerator, such as a screen, keyboard, sound system, or any known type of consumer interface. Further, the refrigerator can communicate with the consumables and cosmetic substance information module, and accordingly can determine the antibiotic suspension's ΔE prior to placement within the refrigerator, and continue to track the antibiotic suspension's ΔE while in the refrigerator. The consumer interface further enables the refrigerator to communicate to the consumer that it contains the particular bottle of antibiotic suspension, information related to ΔE, including current efficacy values of the antibiotic suspension, and when the antibiotic suspension will reach a minimum acceptable efficacy value, indicated by “Minimum” on the vertical axis of the graph. The minimum acceptable value may be automatically provided by the information module, may be determined from input provided by the consumer through the consumer interface, or may be the higher of the two values. In this case the consumer can see how the efficacy value of the antibiotic suspension has degraded prior to purchasing it, and can continue to see how the efficacy value degrades during local storage in his refrigerator after its purchase, and when it will reach its minimum acceptable efficacy value. For example, at the time indicated as 2, the consumer can determine the residual efficacy value of the antibiotic suspension, corresponding to point B and “Residual” on the vertical axis of the graph. Further, the consumer can determine that the antibiotic suspension's efficacy value will reach a minimum acceptable level at time 3, as indicated by “Minimum” on the vertical axis of the graph, thus knowing the window of time in which the antibiotic suspension will maintain an acceptable efficacy level, as indicated by time 1 to 3. Further, the refrigerator can notify the consumer through its consumer interface when the antibiotic suspension's efficacy value has reached or fallen below the minimum acceptable efficacy value.

In fact, if the consumer knows the internal temperature of his own refrigerator prior to purchasing the antibiotic suspension, he can predict the degradation of the efficacy value of the antibiotic suspension that will occur after he purchases it and locally stores it in his refrigerator, thus knowing the window of time in which it will maintain an acceptable efficacy value, as indicated by time 1 to 3. For example, the consumer may utilize an application on his smartphone to store, or even monitor, the internal temperature of his refrigerator. When he goes to the pharmacy, he could scan the antibiotic suspension's dynamic information identifier with his smartphone, and the application can communicate with the consumables and cosmetic substance information module to determine a current ΔE or corresponding residual efficacy value, and predict the ΔE of the antibiotic suspension when stored in his refrigerator. Further, the consumer may utilize such an application on his smartphone to store, or even monitor, the storage conditions associated with various local storage environments, local storage containers, and local storage coupons. In this way, when he goes to the pharmacy or other retailers of consumables and cosmetic substances, he can scan the dynamic information identifier of a wide variety of consumables and cosmetic substances with his smartphone, and the application can communicate with the consumables and cosmetic substance information module to determine a current ΔE or corresponding residual efficacy value, and predict the ΔE of the consumables and cosmetic substance when stored in proximity to the corresponding local storage environment, local storage container, or local storage coupon.

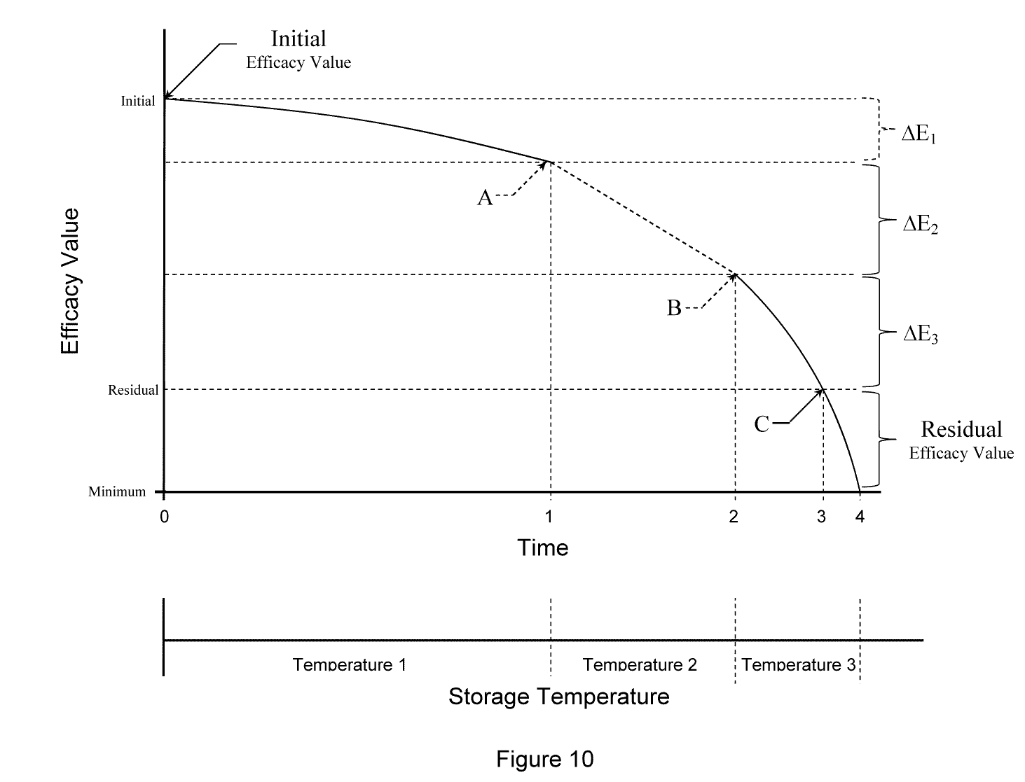

FIG. 10 is a graph showing the function of how an efficacy value of a consumables and cosmetic substance varies over a change in time and multiple changes in a second condition, the storage temperature of the consumables and cosmetic substance. It is understood that change in time and change in storage temperature are offered by way of example, and are in no way limiting to the types on condition changes to which the present inventions may be applied. In this example, the change in an efficacy value of an antibiotic suspension, specifically, the change in its Penicillin concentration is shown over a period of time including its preservation at the pharmacy, a subsequent period of time including its local storage in a consumer's refrigerator (which is one example of a local storage environment as disclosed herein), and further subsequent storage in the consumer's picnic cooler along with a local storage coupon (which is one example of a traditional local storage environment provided with a local storage coupon as disclosed herein). The graph shows that the antibiotic suspension is preserved at a first temperature, Temperature 1, for a first period of time indicated as 0 to 1, while at the pharmacy. The antibiotic suspension is purchased by a consumer at time 1, and subsequently stored at a second temperature, Temperature 2, for a second period of time indicated as 1 to 2, during local storage in the consumer's refrigerator. It is noted that Temperature 2 is greater than Temperature 1, and accordingly the shape of the graph changes at point A when the antibiotic suspension is taken from Temperature 1 and stored at Temperature 2. As in the preservation module, the local storage environment can identify the antibiotic suspension stored within it by reading or scanning its dynamic information identifier, such as when it passes by a scanner provided in the refrigerator door, or alternatively by the consumer entering its dynamic information identifier via a consumer interface provided on the refrigerator, such as a screen, keyboard, sound system, or any known type of consumer interface. Further, the refrigerator can communicate with the consumables and cosmetic substance information module, and accordingly can determine the antibiotic suspension's ΔE, and corresponding residual efficacy value, prior to or upon placement within the refrigerator, and continue to track the antibiotic suspension's ΔE while in the refrigerator. The consumer interface further enables the refrigerator to communicate to the consumer that it contains the particular bottle of antibiotic suspension, information related to its ΔE, including the corresponding residual efficacy value of the antibiotic suspension while stored in the refrigerator. At time 2, the antibiotic suspension is taken from the refrigerator and placed inside the consumer's traditional picnic cooler, along with a local storage coupon, where it is stored at Temperature 3, for a period of time indicated as 2 to 4. It is noted that Temperature 3 is greater than Temperature 2, and accordingly the shape of the graph changes at point B when the antibiotic suspension is taken from Temperature 2 and stored at Temperature 3. The local storage coupon can identify the antibiotic suspension stored within the picnic cooler and in its proximity by reading or scanning its dynamic information identifier (or alternatively by the consumer entering the dynamic information identifier via a consumer interface communicating with the local storage coupon), can communicate with the consumables and cosmetic substance information module, and accordingly can determine the antibiotic suspension's ΔE and corresponding residual efficacy value prior to placement within the cooler, and continue to track the antibiotic suspension's ΔE while in the cooler. The coupon may be provided with a consumer interface, such as a screen, keyboard, sound system, or any known consumer interface, or alternatively, an application on the consumer's smartphone can enable the coupon to communicate with the smartphone such that the smartphone acts as the consumer interface. The consumer interface enables the coupon to communicate to the consumer that the cooler contains the particular bottle of antibiotic suspension, information related to ΔE, including a current residual efficacy value of the antibiotic suspension while stored in the picnic cooler, and when the antibiotic suspension will reach a minimum acceptable efficacy value, indicated by “Minimum” on the vertical axis of the graph. The minimum acceptable efficacy value may be automatically provided by the information module, may be determined from input provided by the consumer through the consumer interface, or may be the higher of the two values. In this case the consumer can see how the efficacy value of the antibiotic suspension has degraded prior to placing it in the picnic cooler along with the local storage coupon, and can continue to see how the efficacy value degrades during local storage in the picnic cooler, and when it will reach its minimum acceptable efficacy value. For example, at the time indicated as 3, the consumer can determine the residual efficacy value of the antibiotic suspension, corresponding to point C and “Residual” on the vertical axis of the graph. Further, the consumer can determine the antibiotic suspension's efficacy value will reach a minimum acceptable level at time 4, as indicated by “Minimum” on the vertical axis of the graph, thus knowing the window of time in which the antibiotic suspension in the picnic cooler will maintain an acceptable efficacy value, as indicated by time 2 to 4. Further, the local storage coupon can notify the consumer through the consumer interface when the antibiotic suspension's efficacy value has reached or fallen below the minimum acceptable efficacy value.

It is understood that local storage environments can comprise any local storage environment for a consumables and cosmetic substance provided with the features enabling it to identify a dynamic information identifier on the consumables and cosmetic substance, track one or more conditions related to a ΔE of the consumables and cosmetic substance, communicate with the consumables and cosmetic substance information module, determine a current ΔE and corresponding residual efficacy value, track and predict the ΔE of the consumables and cosmetic substance while stored therein, and communicate information related to the ΔE to a consumer. Examples of such local storage environments include, but are not limited to: a pantry capable of identifying a dynamic information identifier on bottled liquid medicines and tracking one or more conditions related to a ΔE of the bottled liquid medicines, such as time and storage temperature; a shelf capable of identifying a dynamic information identifier on a container of dry vitamin tablets and tracking one or more conditions related to a ΔE of the dry vitamin tablets, such as time and storage humidity; a refrigerator bin capable of identifying a dynamic information identifier on a bottle of liquid medicine and tracking one or more conditions related to a ΔE of the liquid medicine, such as time, storage temperature, and storage humidity; a drawer capable of identifying a dynamic information identifier on vials of injectable medicaments and tracking one or more conditions related to a ΔE of the injectable medicaments, such as time, storage temperature, and exposure to light; a medicine cabinet capable of identifying a dynamic information identifier on medicaments and tracking one or more conditions related to a ΔE of the medicaments, such as time, storage temperature, storage humidity, and exposure to light. These local storage environments may be provided with a consumer interface, such as a screen, keyboard, sound system, or any known consumer interface. A consumer interface provided with, or communicating with, the local storage environment enables the local storage environment to communicate to the consumer that it contains a particular consumables and cosmetic substance, information related to its ΔE, including current residual efficacy values, while stored in the local storage environment.

It is understood that local storage containers as disclosed herein can comprise any local storage container for a consumables and cosmetic substance provided with features enabling it to identify a dynamic information identifier on the consumables and cosmetic substance, track one or more conditions related to a ΔE of the consumables and cosmetic substance, communicate with the consumables and cosmetic substance information module, determine a current ΔE and corresponding residual efficacy value, track and predict the ΔE of the consumables and cosmetic substance while stored therein, and communicate information related to the ΔE to a consumer. Examples of such local storage containers include, but are not limited to: a plastic, sealable container capable of identifying a dynamic information identifier on consumables and cosmetic substances provided in the form of dry goods and tracking one or more conditions related to a ΔE of the corresponding consumables and cosmetic substances, such as time and storage humidity; a tray capable of identifying a dynamic information identifier on a bottle of liquid soap and tracking one or more conditions related to a ΔE of the liquid soap, such as time, storage temperature, and exposure to light; a resealable bag capable of identifying a dynamic information identifier on injection syringes pre-filled with lyophilized medicament and tracking one or more conditions related to a ΔE of the lyophilized medicament, such as time, storage temperature, and storage humidity; a purse capable of identifying a dynamic information identifier associated with a medicament pill and tracking one or more conditions related to a ΔE of the medicament pill, such as time, storage temperature, storage humidity, and exposure to light; a picnic cooler capable of identifying a dynamic information identifier on antibiotic suspension and tracking one or more conditions related to a ΔE of the antibiotic suspension, such as time and storage temperature. A consumer interface provided with, or communicating with, the local storage container enables the local storage container to communicate to the consumer that it contains a particular consumables and cosmetic substance, information related to its ΔE, including current residual efficacy values, while stored in the local storage container.

It is understood that local storage coupons according to the present invention can comprise any form of tag, badge, transponder, label, or any other device, individually and collectively referred to herein as a coupon, placed in proximity to a traditional local storage environment or traditional local storage container, and capable of identifying a dynamic information identifier on a consumables and cosmetic substance stored in the traditional local storage environment or traditional local storage container, tracking one or more conditions related to a ΔE of the consumables and cosmetic substance, communicating with the consumables and cosmetic substance information module, determining a current ΔE and corresponding residual efficacy value, tracking and predicting the ΔE of the consumables and cosmetic substance stored in the corresponding local storage environment or traditional local storage container, and communicating information related to the ΔE to a consumer. Examples of such local storage coupons include, but are not limited to: a coupon placed in a plastic container with consumables and cosmetic substance provided in the form of dry goods, wherein the coupon is capable of identifying a dynamic information identifier on or associated with the consumables and cosmetic substance and tracking one or more conditions related to a ΔE of the consumables and cosmetic substance, such as time and storage humidity; a coupon placed on a tray for holding toiletries, wherein the coupon is capable of identifying a dynamic information identifier on the toiletries and tracking one or more conditions related to a ΔE of the toiletries, such as time, storage temperature, and exposure to light; a coupon placed within a resealable freezer bag, wherein the coupon is capable of identifying a dynamic information identifier on bottle of pain killers placed within the resealable freezer bag and tracking one or more conditions related to a ΔE of the bottle of pain killers, such as time, storage temperature, and storage humidity; a coupon placed within a purse, wherein the coupon is capable of identifying a dynamic information identifier on a medicament package placed within the purse and tracking one or more conditions related to a ΔE of the corresponding medicament, such as time, storage temperature, storage humidity, and exposure to light; a coupon attached to the inner surface of a picnic cooler, wherein the coupon is capable of identifying a dynamic information identifier on antibiotic suspension stored in the cooler and tracking one or more conditions related to a ΔE of the antibiotic suspension, such as time and storage temperature; a coupon hung in a pantry, wherein the coupon is capable of identifying a dynamic information identifier on bottled liquid soap and tracking one or more conditions related to a ΔE of the bottled liquid soap, such as time and storage temperature; a coupon attached to a shelf, wherein the coupon is capable of identifying a dynamic information identifier on make-up and tracking one or more conditions related to a ΔE of the make-up, such as time and storage humidity; a coupon attached to an inner surface of a refrigerator bin, wherein the coupon is capable of identifying a dynamic information identifier on a syringe of probiotics and tracking one or more conditions related to a ΔE of the probiotics, such as time, storage temperature, and storage humidity; a coupon placed within a drawer, wherein the coupon is capable of identifying a dynamic information identifier on vials of lyophilized medicament and tracking one or more conditions related to a ΔE of the lyophilized medicament, such as time, storage temperature, and exposure to light; a coupon attached to the inner surface of a medicine cabinet, wherein the coupon is capable of identifying a dynamic information identifier on packaged medicaments and tracking one or more conditions related to a ΔE of the packaged medicaments, such as time, storage temperature, storage humidity, and exposure to light.

In FIG. 1, Creation module 200 can dynamically encode consumables and cosmetic substances to enable the tracking of changes in efficacy value of the consumables and cosmetic substance, or ΔE. This dynamic encoding, also referred to herein as a dynamic information identifier, can replace and/or complement existing consumables and cosmetic substance marking systems such as barcodes, labels, and/or ink markings. This dynamic encoding, or dynamic information identifier, can be used to make consumables and cosmetic substance information from creation module 200 available to information module 100 for use by preservation module 300, transformation module 400, dispensing module 500, and/or consumption module 600, which includes the ultimate consumer of the consumables and cosmetic substance. One method of marking the consumables and cosmetic substance with a dynamic information identifier by creation module 200, or any other module in consumables and cosmetic substance supply system 10, could include an electronic tagging system, such as the tagging system manufactured by Kovio of San Jose, Calif., USA. Such thin film chips can be used not only for tracking consumables and cosmetic substances, but can include components to measure attributes of consumables and cosmetic substances, and record and transmit such information. Such information may be readable by a reader including a satellite-based system. Such a satellite-based consumables and cosmetic substance information tracking system could comprise a network of satellites with coverage of some or all the surface of the earth, so as to allow the dynamic efficacy value database of information module 100 real time, or near real time updates about a ΔE of a particular consumables and cosmetic substance.

Preservation module 300 includes packers and shippers of consumables and cosmetic substances. The tracking of changes in efficacy values, or ΔE, during the preservation period within preservation module 300 allows for dynamic expiration dates for consumables and cosmetic substances. For example, expiration dates for medicament products are currently based generally only on time using assumptions regarding minimal conditions at which the corresponding medicament products are maintained. This extrapolated expiration date is based on a worst-case scenario for when the product becomes unsafe to consume during the preservation period, or when an efficacy value drops below an acceptable minimum value. In reality, the degradation of medicament products may be significantly less than this worst-case. If preservation module 300 could measure or derive the actual degradation information such as ΔE, an actual expiration date, referred to herein as a dynamic expiration date, can be determined dynamically, and could be significantly later in time than an extrapolated expiration date. This would allow the consumables and cosmetic substance supply system to dispose of fewer products due to expiration dates. This ability to dynamically generate expiration dates for consumables and cosmetic substances is of particular significance when consumables and cosmetic substances contain few or no preservatives, which is often the case.

It should be noted that a dynamic expiration date need not be indicated numerically (i.e., as a numerical date) but could be indicated symbolically as by the use of colors—such as green, yellow and red employed on semaphores—or other designations. In those instances, the dynamic expiration date would not be interpreted literally but, rather, as a dynamically-determined advisory date. In practice a dynamic expiration date will be provided for at least one component of a single or multi-component consumables and cosmetic substance. For multi-component consumables and cosmetic substances, the dynamic expiration date could be interpreted as a “best” date for consumption for particular components.

By law, in many localities, consumables and cosmetic substance processors such as those in transformation module 400 are required to provide consumables and cosmetic substance information regarding their products. Often, this information takes the form of an ingredient table applied to the packaging of the consumables and cosmetic substance. Currently, the information in this ingredient table is based on averages or minimums for their typical product. Using the consumables and cosmetic substance information from information module 100 provided by creation module 200, preservation module 300, and/or information from the transformation of the consumables and cosmetic substance by transformation module 400, and consumer feedback and updates related to ΔE, preferably obtained through or provided by local storage environments, local storage containers, and local storage coupons, the consumables and cosmetic substance processor could include a dynamically generated efficacy value table, also referred to herein as a dynamic efficacy value table, for the actual consumables and cosmetic substance being supplied to consumers and further being locally stored by consumers. The information in such a dynamic efficacy value table could be used by dispensing module 500 for adaptively dispensing the consumables and cosmetic substance, and/or used by consumption module 600, so as to allow the ultimate consumer the ability to select the most desirable consumables and cosmetic substance which meets their needs, and/or to track information regarding consumables and cosmetic substances consumed.

Information about changes in efficacy values of consumables and cosmetic substances, or ΔE, is particularly useful in the dispensing module 500, as it allows knowing, or estimating, a ΔE prior to dispensing, and the corresponding pre-dispensing state of the efficacy values of the consumables and cosmetic substance, including the changes in efficacy values occurring during local storage of the consumables and cosmetic substance, and further enables the determination of dispensing parameters responsive to the ΔE occurring prior to dispensing. The dispensing module 500 can thereby provide adaptive dispensing parameters, such as by modifying existing or baseline dispensing parameters, to deliver a desired amount of efficacy content. The pre-dispensing ΔE and corresponding efficacy value of a consumables and cosmetic substance is not tracked or provided to the consumer by existing local storage environments, local storage containers, dispensing devices or individuals. However, using information provided by information module 100 from creation module 200, preservation module 300, transformation module 400, and consumer feedback and updates related to ΔE, preferably obtained through or provided by local storage environments, local storage containers, and local storage coupons, and/or information measured or generated by dispensing module 500, and/or consumer input regarding efficacy value or a desired amount of efficacy content provided through the dispensing module 500, dispensing module 500 can provide the consumer with the actual, and/or estimated change in efficacy values of the consumables and cosmetic substance, or ΔE, prior to dispensing, and can further provide adaptive dispensing parameters responsive to the ΔE and the consumer's input to deliver a desired amount of efficacy content.

An important benefit provided by local storage environments and local storage containers disclosed herein is that consumer feedback and updates related to ΔE, such as observed or measured information of, or related to, a ΔE during local storage of the consumables and cosmetic substance is obtained through, or provided by, the local storage environments, containers, and coupons. In this way consumer feedback and updates related to a ΔE during local storage of a consumables and cosmetic substance can play a role in updating the dynamic efficacy value information about the consumables and cosmetic substances consumers have purchased and placed in local storage, such as through modification of ΔE. Such information regarding the change to efficacy value of the consumables and cosmetic substance, or ΔE, could be provided not only to a consumer through the consumption module 600 and dispensing module 500, but could also be provided to information module 100 for use by creation module 200, preservation module 300, transformation module 400, so as to track, and possibly improve consumables and cosmetic substances throughout the entire consumables and cosmetic substance supply system 10.

The information regarding consumables and cosmetic substances provided by information module 100 to consumption module 600 can replace or complement existing traditional information sources such as, but not limited to, traditional labeling, consumables and cosmetic substance websites like www.webmd.com, www.doctoroz.com, and consumables and cosmetic substance manufacturer's websites. Through the use of specific information regarding a consumables and cosmetic substance from information module 100, consumers can use consumption module 600 to select consumables and cosmetic substances according to ΔE information and residual efficacy values. This will further allow consumers to make informed decisions regarding consumables and cosmetic substance additives, preservatives, origins, traceability, and other consumables and cosmetic substance attributes that may also be tracked through the information module 100. This information can be provided by consumption module 600 through personal computers, laptop computers, tablet computers, and/or smartphones. Software running on these devices can include dedicated computer programs, modules within general programs, and/or smartphone apps. An example of an analogous smartphone app for consumables and cosmetic substances is the iOS ShopNoGMO from the Institute for Responsible Technology. This iPhone app allows consumers access to information regarding non-genetically modified organisms they may select. Additionally, consumption module 600 may provide information for the consumer to operate dispensing module 500 with adaptive dispensing parameters, wherein the adaptive dispensing parameters are responsive to a ΔE or corresponding residual efficacy value of the consumables and cosmetic substance being dispensed and may further be responsive to the consumer's input related to the ΔE, the corresponding efficacy value, or the corresponding amount of efficacy content to be dispensed. In this way, the amount of efficacy content in the dispensed consumables and cosmetic substance can be optimized or maintained, according to, but not limited to: a target amount based on the consumer's input regarding his needs or preference; a target amount established by the provider of the consumables and cosmetic substance, such as the transformer; a target amount established by a dispenser of the consumables and cosmetic substance, such as a service provider; or a target amount equal to a predetermined amount of efficacy content recommended by the labeling or product information provided with the consumables and cosmetic substance.

Through the use of consumables and cosmetic substance information available from information module 100, the consumables and cosmetic substance supply system 10 can track efficacy values of consumables and cosmetic substances. Using this information, consumables and cosmetic substances travelling through consumables and cosmetic substance supply system 10 can be dynamically valued and priced according to efficacy values. For example, consumables and cosmetic substances with longer dynamic expiration dates (longer shelf life) may be more highly valued than consumables and cosmetic substances with shorter expiration dates. Additionally, consumables and cosmetic substances with higher efficacy values may be more highly valued, not just by the consumer, but also by each entity within consumables and cosmetic substance supply system 10. This is because each entity will want to start with a consumables and cosmetic substance with higher efficacy value before it performs its function and passes the consumables and cosmetic substance along to the next entity. Therefore, both the starting efficacy values and the ΔE associated with those values are important factors in determining or estimating an actual, or residual, efficacy value of a consumables and cosmetic substance, and accordingly are important factors in establishing dynamically valued and priced consumables and cosmetic substances.

The use of local storage environments, local storage containers, and local storage coupons disclosed herein can beneficially make information related to a ΔE of a locally stored consumables and cosmetic substance available to information module 100, so that information available from information module 100 can enable a consumer, or any entity inside or outside the consumables and cosmetic substance supply system 10, to track the corresponding efficacy value of the consumables and cosmetic substance during its local storage. It is understood that such local storage includes local storage by any entity that provides or otherwise dispenses consumables and cosmetic substances for consumption by a consumer, and could include the consumer's residence, a pharmacy, a hospital, a supermarket, a vending machine, or any other known entity providing consumables and cosmetic substances for consumption.

During the period of implementation of the present inventions, there will be consumables and cosmetic substances being marketed including those benefiting from the tracking of dynamic efficacy information such as ΔE, also referred to herein as information-enabled consumables and cosmetic substances, and consumables and cosmetic substances which do not benefit from the tracking of dynamic nutritional information such as ΔE, which are not information enabled and are referred to herein as dumb consumables and cosmetic substances. Information-enabled consumables and cosmetic substances would be available in virtual internet marketplaces, as well as traditional marketplaces. Because of information provided by information-enabled consumables and cosmetic substances, entities within the consumables and cosmetic substance supply system 10, including consumers, would be able to review and select information-enabled consumables and cosmetic substances for purchase. It should be expected that, initially, the information-enabled consumables and cosmetic substances would enjoy a higher market value and price than dumb consumables and cosmetic substances. However, as information-enabled consumables and cosmetic substances become more the norm, the cost savings from less waste due to degradation of information-enabled consumables and cosmetic substances could lead to their price actually becoming less than dumb consumables and cosmetic substances.

For example, the manufacturer of a skin lotion with Aloe vera would prefer to use Aloe vera concentrate of a high efficacy value in the production of its product, the skin lotion with Aloe vera, so as to produce a premium product of high efficacy value. Depending upon the levels of the efficacy values in the skin lotion with Aloe vera, the manufacturer may be able to charge a premium price and/or differentiate its product from that of other manufacturers. When selecting the Aloe vera concentrate to be used in the ready-to-eat dinner, the manufacturer will seek Aloe vera concentrate of high efficacy value from preservation module 300 that meets its requirements for efficacy value. The packager/shipper of preservation module 300 would also be able to charge a premium for Aloe vera concentrate which has high efficacy values upon delivery to the manufacturer of the skin lotion, and therefore is incentivized to select Aloe vera concentrate of high efficacy value from the transformation module 400, such as a processor of Aloe vera concentrate. The concentrate processor will be able to charge a premium for Aloe vera concentrate of high efficacy value, and will select Aloe vera leafs of high efficacy value from the preservation module 300, such as a produce packager/shipper. The produce packager/shipper of preservation module 300 would also be able to charge a premium for Aloe vera leafs which have high efficacy values, and therefore is inclined to select Aloe vera leafs of high efficacy value from the grower of creation module 200, who will also be able to charge a premium for Aloe vera leafs of high efficacy value.

Further, the consumer of the skin lotion with Aloe vera may want to, or in the case of a hotel, spa, hospital, or any other regulated service provider or dispenser, may be required to, track the efficacy value of the skin lotion during its local storage. Local storage environments, local storage containers, and local storage coupons disclosed herein enable such tracking by making information related to ΔE during local storage available to information module 100 for updating the dynamic efficacy values of consumables and cosmetic substances.

The change in efficacy value for a consumables and cosmetic substance, or ΔE, tracked through the consumables and cosmetic substance supply system 10 by consumables and cosmetic substance information from information module 100 can be preferably determined from measured information. However, some or all such consumables and cosmetic substance ΔE information may be derived through measurements of environmental conditions of the consumables and cosmetic substance as it travels through the consumables and cosmetic substance supply system 10. Additionally, some or all of the consumables and cosmetic substance ΔE information can be derived from ΔE data of other consumables and cosmetic substances which have traveled through consumables and cosmetic substance supply system 10. Consumables and cosmetic substance ΔE information can also be derived from laboratory experiments performed on other consumables and cosmetic substances, which may approximate conditions and/or processes to which the actual consumables and cosmetic substance has been exposed.

For example, laboratory experiments can be performed on over-the-counter medicaments to determine the effect on, or change in, corresponding efficacy values, for a variety of environmental conditions the over-the-counter medicaments may be exposed to during packaging and shipment in preservation module 300, or during local storage by a consumer or dispenser. Using this experimental data, tables and/or algorithms could be developed which would predict the level of change of efficacy values, or ΔE, for a particular over-the-counter medicament based upon information collected regarding the environmental conditions to which the over-the-counter medicament was exposed during its time in preservation module 300 or local storage. While the ultimate goal for consumables and cosmetic substance supply system 10 would be the actual measurement of efficacy values to determine ΔE, use of derived efficacy values from experimental data to determine ΔE would allow improved logistics planning because it provides the ability to prospectively estimate changes to efficacy values, or ΔE, and because it allows more accurate tracking of changes to efficacy values, or ΔE, while technology and systems are put in place to allow actual measurement.

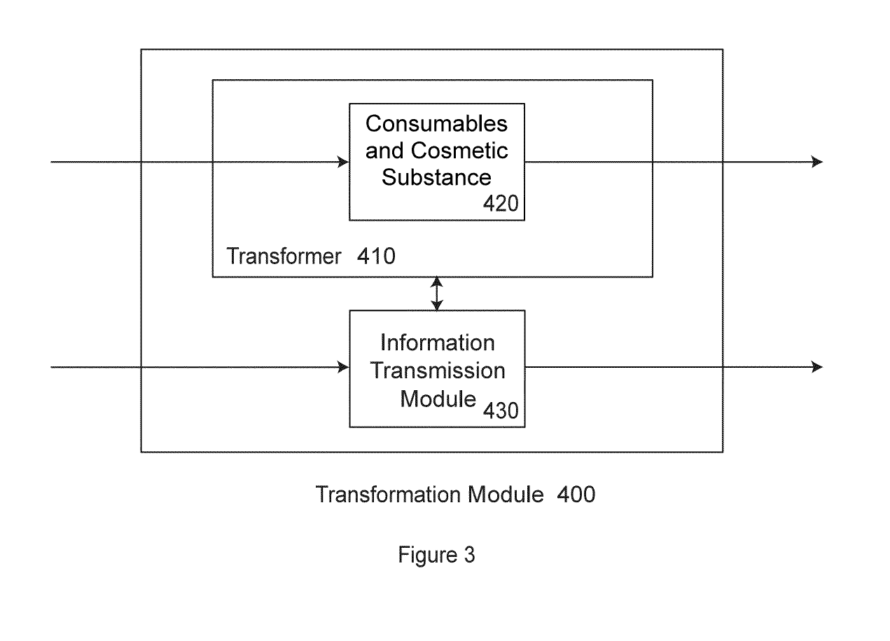

FIG. 3 shows an embodiment of transformation module 400 of the present invention. Transformation module 400 includes transformer 410, which acts upon consumables and cosmetic substance 420, and information transmission module 430. When transformer 410 receives a consumables and cosmetic substance 420, information transmission module 430 also receives, or retrieves information about the particular consumables and cosmetic substance 420 that is to be transformed. This information can include creation information, preservation information, packaging information, shipping information, and possibly previous transformation information. After consumables and cosmetic substance 420 has been transformed by transformer 410, such information is passed along with the transformed consumables and cosmetic substance 420 by the information transmission module 430.

For example, Omega oil that arrives for processing into an Omega oil gel cap vitamin supplement by transformer 410 has information associated with it, which may include, but is not limited to, the Omega oil variety, animal source, fishery identity, when it was extracted, if it was raised organic, how the animal source was stored prior to extraction, chemical agents used for extraction, food sources used for growing the source animal, antibiotic and hormones used during animal source growth, and so forth. There may also be information on specific efficacy values of the Omega oil when it was preserved for shipment. This information may be stored in the labeling of the Omega oil. However, it may be stored in a database maintained by the fishery, the extractor, the shipper, or the consumables and cosmetic substances industry. Such a database is referred to herein as a dynamic efficacy value database. The information in the dynamic efficacy value database regarding the Omega oil is referenced to a dynamic information identifier provided with the Omega oil product, and may be accessed by means of telecommunications systems, such as, but not limited to, wireless telecommunication systems.

Additionally, the Omega oil may have information associated with it regarding how it was preserved for shipment from the Omega oil extractor to the Omega oil gel cap vitamin supplement manufacturer of transformation module 400. Such information may include historical information on the type of container it was shipped in, the environment exterior the container it was shipped in, internal conditions of the container and actual information about the Omega oil during the shipment. Additionally, if the preservation system acted upon such information in preserving the Omega oil, information about the preservation measures may also be available. Such information may be stored in the preservation system. However, it may be stored in a database maintained by, but not limited to, the extractor, the shipper, or the consumables and cosmetic substances industry, also referred to herein as a dynamic efficacy value database. The information in the dynamic efficacy value database regarding the Omega oil is referenced to a dynamic information identifier provided with the Omega oil product, and may be accessed by means of telecommunications systems, such as, but not limited to, wireless telecommunication systems.

In the example where the consumables and cosmetic substance 420 is Omega oil, transformer 410 processes the Omega oil into gel caps by combining it with other consumables and cosmetic ingredients, such as USP Grade Gelatin. The transformer 410 packages the gel caps in bottles and labels the bottles. The label on the bottle may contain all the information provided to information transmission module 430. Preferably, this information is referenced by a dynamic encode or tag, herein referred to as a dynamic information identifier, which identifies the information that is being transmitted by information transmission module 430 regarding the Omega oil in the gel caps in the bottle.

In practice, information transmission module 430 would receive the information regarding the consumables and cosmetic substance 420 from a database that is being used to track the Omega oil during its journey from the fishery to the consumer. When transformer 410 transforms consumables and cosmetic substance 420, information transmission module 430 retrieves the appropriate information from the database and transmits it to another database. Alternatively, the information retrieved by transmission module 430 would be transmitted back to the original database, noting that the transformation had occurred. Preferably, the information regarding the Omega oil retrieved by transmission module 430 would simply be appended with the information that the transformation had occurred. Such databases are individually and collectively referred to herein as a dynamic efficacy value database.

If the consumables and cosmetic substance 420 can no longer be tracked by the reference information or the dynamic information identifier that accompanied it from its creator, then new reference information or a new dynamic information identifier may be created. For example, in this case the Omega oil is combined with USP Grade Gelatin in the transformer 410 to make Omega oil gel caps, so the information for both the Omega oil and the USP Grade Gelatin may be combined and assigned a new reference number or a new dynamic information identifier. Preferably, a new entry is created in the dynamic efficacy value database, with references to the information related to the Omega oil and the information related to the USP Grade Gelatin.

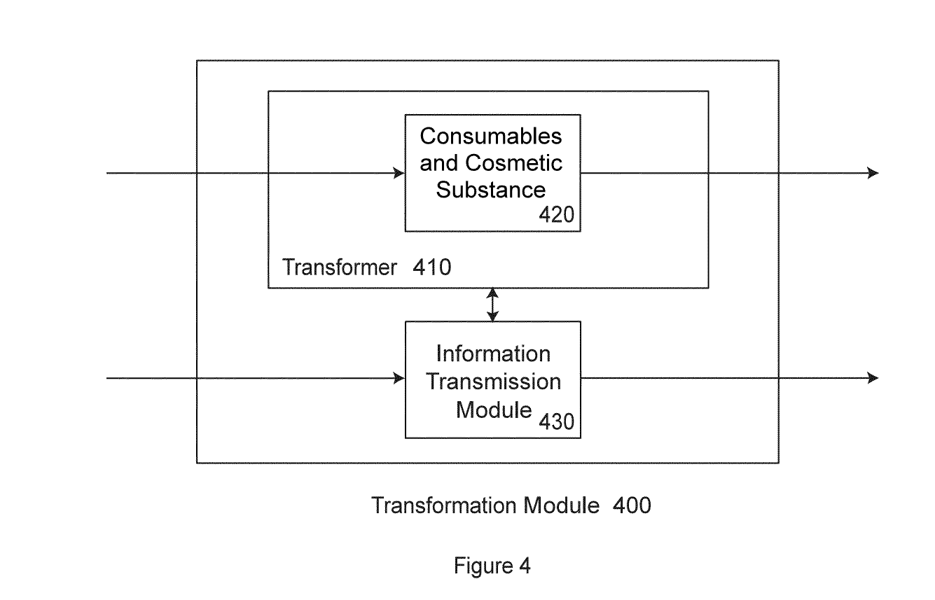

FIG. 4 shows another embodiment of transformation module. Transformation module 400 includes transformer 410, which acts upon consumables and cosmetic substance 420, and information transmission module 430. When transformer 410 receives a consumables and cosmetic substance 420, information transmission module 430 also receives, or retrieves information about the particular consumables and cosmetic substance 420 that is to be transformed. This information can include creation information, packaging information, shipping information, and possibly previous transformation information. After consumables and cosmetic substance 420 has been transformed by transformer 410, such information is passed along with the transformed consumables and cosmetic substance 420 by the information transmission module 430, along with specific information relating to the transformation done by transformer 410.

To further the example wherein the consumables and cosmetic substance 420 is Omega oil used to manufacturer Omega oil gel caps, the transformer 410 processes the Omega oil into gel caps by combining it with other consumables and cosmetic ingredients, such as USP Grade Gelatin. During this transformation of the consumables and cosmetic substance 420 by transformer 410, information about the transformation can be captured by transformer 410 and sent to information transmission module 430. This information can include how the transformation was accomplished; including information on the transformer used, the formulation implemented by transformer 410, and the settings for transformer 410 when the transformation occurred. Additionally, any information created during the transformation by transformer 410 can be sent to the information transmission module 430. This could include, but is not limited to, measured information, such as the actual processing temperature, length of time of each of processing step, or weight or volume measurements. Additionally, this information could include measured efficacy values.

The transformer 410 packages the gel caps in bottles and labels the bottles. The label on the bottle may contain all the information provided to information transmission module 430, including information about the transformation by transformer 410. Preferably, this information is referenced by a dynamic encode or tag, herein referred to as a dynamic information identifier, which identifies the information that is being transmitted by information transmission module 430 regarding the Omega oil in the gel caps in the bottle.

In practice, information transmission module 430 would receive the information regarding the consumables and cosmetic substance 420 from a database that is being used to track the Omega oil during its journey from the fishery to the consumer. When transformer 410 transforms consumables and cosmetic substance 420, information transmission module 430 retrieves the appropriate information from the database, appends it with the information from transformer 410 regarding the transformation, and transmits it to another database. Alternatively, such information would be transmitted back to the original database, including the transformation information. Preferably, the information regarding the Omega oil would simply be appended with the information from transformer 410 about the transformation. Such databases are individually and collectively referred to herein as a dynamic efficacy value database.

If the consumables and cosmetic substance 420 can no longer be tracked by the reference information or the dynamic information identifier that accompanied it from its creator, then new reference information or a new dynamic information identifier may be created. For example, in this case the Omega oil is combined with USP Grade Gelatin in the transformer 410 to make Omega oil gel caps, so the information for both the Omega oil and the USP Grade Gelatin may be combined and assigned a new reference number or a new dynamic information identifier. Preferably, a new entry is created in the dynamic efficacy value database, with references to the information related to the Omega oil, the information related to the USP Grade Gelatin, and the information related to the transformation by transformer 410.

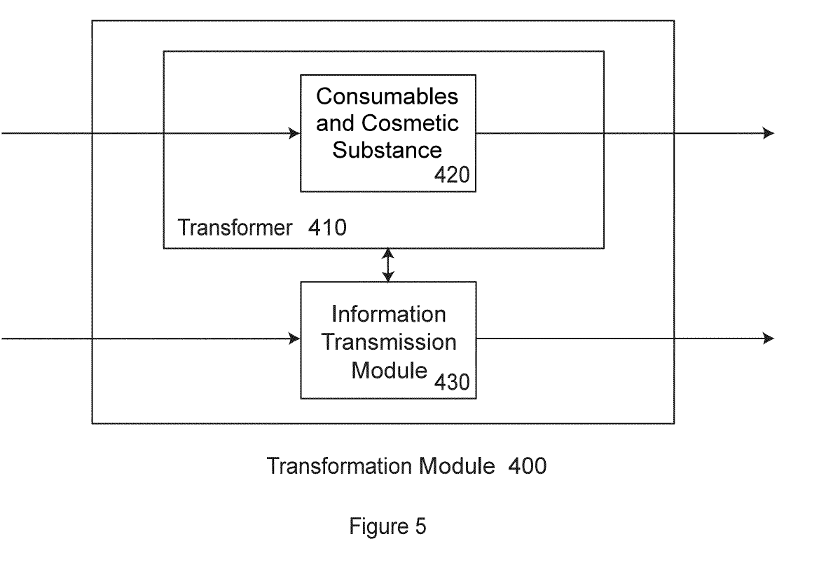

FIG. 5 shows another embodiment of transformation module 400. Transformation module 400 includes transformer 410, which acts upon consumables and cosmetic substance 420, and information transmission module 430. When transformer 410 receives a consumables and cosmetic substance 420, information transmission module 430 also receives, or retrieves information about the particular consumables and cosmetic substance 420 that is to be transformed. This information can include creation information, packaging information, shipping information, previous transformation information, and ΔE information or corresponding residual efficacy value. The ΔE information or corresponding residual efficacy value is used by transformer 410 to dynamically modify the transformation processing parameters, referred to herein as adaptive transformation. After consumables and cosmetic substance 420 has been adaptively transformed by transformer 410, such information is passed along with the adaptively transformed consumables and cosmetic substance 420 by the information transmission module 430, along with specific information relating to the adaptive transformation done by transformer 410.

To further the example wherein the consumables and cosmetic substance 420 is Omega oil used to manufacturer Omega oil gel caps, the transformer 410 adaptively transforms the Omega oil into gel caps by combining it with other consumables and cosmetic ingredients, such as USP Grade Gelatin, using processing parameters that are responsive to the ΔE information or corresponding residual efficacy value of the Omega oil. In this way, transformer 410 can dynamically modify its processing of consumables and cosmetic substance 420 in response to its ΔE or current efficacy values to preserver or improve or minimize the degradation of the efficacy values in the resulting adaptively transformed consumables and cosmetic substance.

During this adaptive transformation of the consumables and cosmetic substance 420 by transformer 410, information about the transformation can be captured by transformer 410 and sent to information transmission module 430. This information can include how the transformation was accomplished; including information on any dynamic modifications of processing parameters made in response to ΔE information or corresponding residual efficacy values about the ingredient consumables and cosmetic substances transformed, the formulation implemented by transformer 410, and the settings for transformer 410 when the transformation occurred. Additionally, any information created during the adaptive transformation by transformer 410 can be sent to the information transmission module 430. This could include measured information, such as the actual processing temperatures, length of time of each processing step, weights, volumes, and so forth. Further, this information could include measured or estimated ΔE information or corresponding residual efficacy values.

The transformer 410 packages the gel caps in bottles and labels the bottles. The label on the bottle may contain all the information provided to information transmission module 430, including information about the adaptive transformation by transformer 410. Preferably, this information is referenced by a dynamic encode or tag, herein referred to as a dynamic information identifier, which identifies the information that is being transmitted by information transmission module 430 regarding the Omega oil in the gel caps in the bottle.

In practice, information transmission module 430 would receive the information regarding the consumables and cosmetic substance 420 from a database that is being used to track the Omega oil during its journey from the fishery to the consumer. When transformer 410 adaptively transforms consumables and cosmetic substance 420, information transmission module 430 retrieves the appropriate information from the database, appends it with the information from transformer 410 regarding the adaptive transformation, and transmits it to another database. Alternatively, such information would be transmitted back to the original database, including the adaptive transformation information. Preferably, the information regarding the Omega oil would simply be appended with the information from transformer 410 about the adaptive transformation. Such databases are individually and collectively referred to herein as a dynamic efficacy value database.

If the consumables and cosmetic substance 420 can no longer be tracked by the reference information or the dynamic information identifier that accompanied it from its creator, then new reference information or a new dynamic information identifier may be created. For example, in this case the Omega oil is combined with USP Grade Gelatin in the transformer 410 and adaptively transformed to make Omega oil gel caps, so the information for both the Omega oil and the USP Grade Gelatin may be combined and assigned a new reference number or a new dynamic information identifier. Preferably, a new entry is created in the dynamic efficacy value database, with references to the information related to the Omega oil, the information related to the USP Grade Gelatin, and the information related to the adaptive transformation by transformer 410.

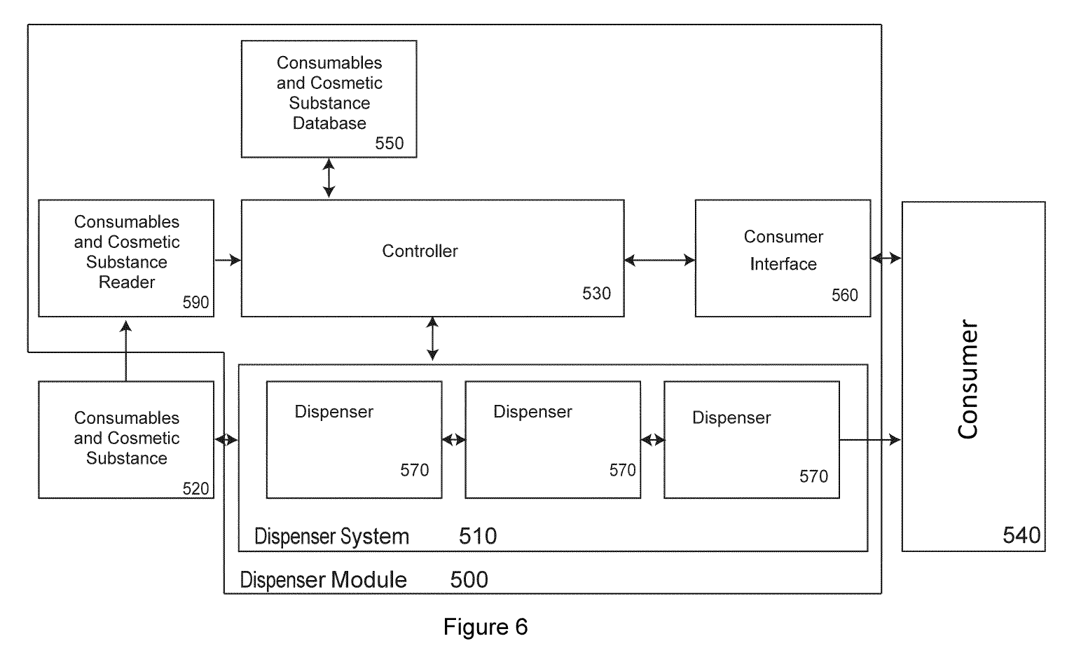

FIG. 6 shows an illustrative embodiment of dispensing module 500 as disclosed herein. Dispenser system 510 receives consumables and cosmetic substance 520 for dispensing to consumer 540. It is understood that dispenser system 510 may also function as a local storage environment for consumables and cosmetic substance 520 while contained therein. Controller 530 is operably connected to dispenser system 510. In fact, controller 530 may be integrated within dispenser system 510, or provided as a separate device communicating with dispenser system 510. Further, controller 530 directly or indirectly communicates with consumables and cosmetic substance database 550.

It is important to note that while FIG. 6 shows consumables and cosmetic substance database 550 as part of the dispensing module 500, it is in no way limited to this interpretation. It is understood that this convention is only one way of illustrating the inventions described herein, and it is further understood that this is in no way limiting to the scope of the inventions disclosed herein. For example, consumables and cosmetic substance database 550 can be contained within information module 100, dispensing module 500, or elsewhere.

When dispenser system 510 receives consumables and cosmetic substance 520 for dispensing, consumables and cosmetic substance reader 590 either receives information regarding consumables and cosmetic substance 520 and provides it to controller 530, which is the case if the consumables and cosmetic substance 520 contains a label which includes the information about consumables and cosmetic substance 520, and/or the consumables and cosmetic substance reader 590 receives reference information allowing retrieval of the information and provides it to controller 530, which is the case if the consumables and cosmetic substance 520 is associated with, or provided with a dynamic information identifier. In the case where consumables and cosmetic substance 520 contains a label which includes the desired information about consumables and cosmetic substance 520, consumables and cosmetic substance reader 590 reads this information, provides it to controller 530, which makes it available to consumer 540 by means of consumer interface 560.

In an example, consumables and cosmetic substance 520 could be a skin lotion with Aloe vera which is to be delivered to a consumer by dispenser system 510, which is an automated electronic pump for delivering precise liquid volumes. Consumables and cosmetic substance reader 590 would read a label on consumables and cosmetic substance 520, the skin lotion, and may thereby receive information regarding consumables and cosmetic substance 520, and then provide the information to controller 530. This information could include creation information as to the creation of the various components which constitute the skin lotion with Aloe vera. This information could include information about the source, origin and creation of the Aloe vera derived phytochemicals, information regarding prior preservation and transformation of the Aloe vera and its derivatives, as well how the skin lotion transformer transformed the components into the skin lotion, such as the formulation used, actual measured conditions during the transformation, an measured or estimated ΔE or corresponding residual efficacy values.

While such information could be stored on the label located on the packaging for consumables and cosmetic substance 520 so as to be read by consumables and cosmetic substance reader 590, provided to controller 530, and provided to consumer interface 560 for display to consumer 540, preferably, the label on the consumables and cosmetic substance package includes reference information, such as a dynamic information identifier, which is read by consumables and cosmetic substance reader 590 and provided to controller 530 that allows controller 530 to retrieve the information about consumables and cosmetic substance 520 from consumables and cosmetic substance database 550. An example of such a label could be, but is not limited to, a QR code that provides the dynamic information identifier and further provides a URL to hotlink the controller 530 to the consumables and cosmetic substance database 550. Additionally, consumers may provide feedback and updates regarding observed or measured changes in the efficacy values of consumables and cosmetic substance 520.

Consumables and cosmetic substance database 550 could be a database maintained by the transformer of consumables and cosmetic substance 520 for access by consumers of such consumables and cosmetic substance 520 to track or estimate changes in the efficacy values of those consumables and cosmetic substances, as well as any other information about the consumables and cosmetic substance that can be tracked, including but not limited to the examples previously described. However, preferably, consumables and cosmetic substance database 550 is a database maintained by the consumables and cosmetic substance industry for all such information regarding consumables and cosmetic substances grown, raised, preserved, transformed, dispensed and consumed by consumer 540, and may further be contained within information module 100. Such a database is also referred to herein as a dynamic efficacy value database.

It is understood that dispenser system 510 could be a singular dispenser device 570 or a plurality of dispenser devices 570 which can be selectively operated by controller 530 to prepare and deliver consumables and cosmetic substance 520. For example, dispenser system 510 can be a single dispenser 570, such as, but not limited to, an electric pump, pill counter, weight scale, or a human. Alternatively, dispenser system 510 may be a plurality of dispensers 570. In the case where a plurality of dispensers 570 comprise dispenser system 510, consumables and cosmetic substance 520 may be manually or automatically transferred between dispensers 570 for eventual transfer to consumer 540.

Consumables and cosmetic substance reader 590 may be an automatic reader such as a barcode or QR code reader or RFID sensor which receives information from consumables and cosmetic substance 520, preferably including a reference code from consumables and cosmetic substance 520 such as a dynamic information identifier associated with or provided with the consumables and cosmetic substance 520, and provides this information to controller 530. Consumables and cosmetic substance reader 590 might also be a manual entry system where the reference code, such as a dynamic information identifier associated with or provided with the consumables and cosmetic substance 520 is manually entered into consumables and cosmetic substance reader 590 for use by controller 530, or may alternatively be manually entered into consumer interface 560 for use by controller 530.

Consumables and cosmetic substance database 550 could be a flat database, relational database or, preferably, a multi-dimensional database. Consumables and cosmetic substance database 550 could be local but, preferably, it would be located remotely, such as on the internet, and accessed via a telecommunication system, such as a wireless telecommunication system. Controller 530 can be implemented using a computing device, such as a micro-controller, micro-processor, personal computer, or tablet computer. Controller 530 could be integrated to include consumables and cosmetic substance reader 590, consumer interface 560, and/or consumables and cosmetic substance database 550. Additionally, controller 530 may be integrated in dispenser system 510, including integration into dispenser 570.

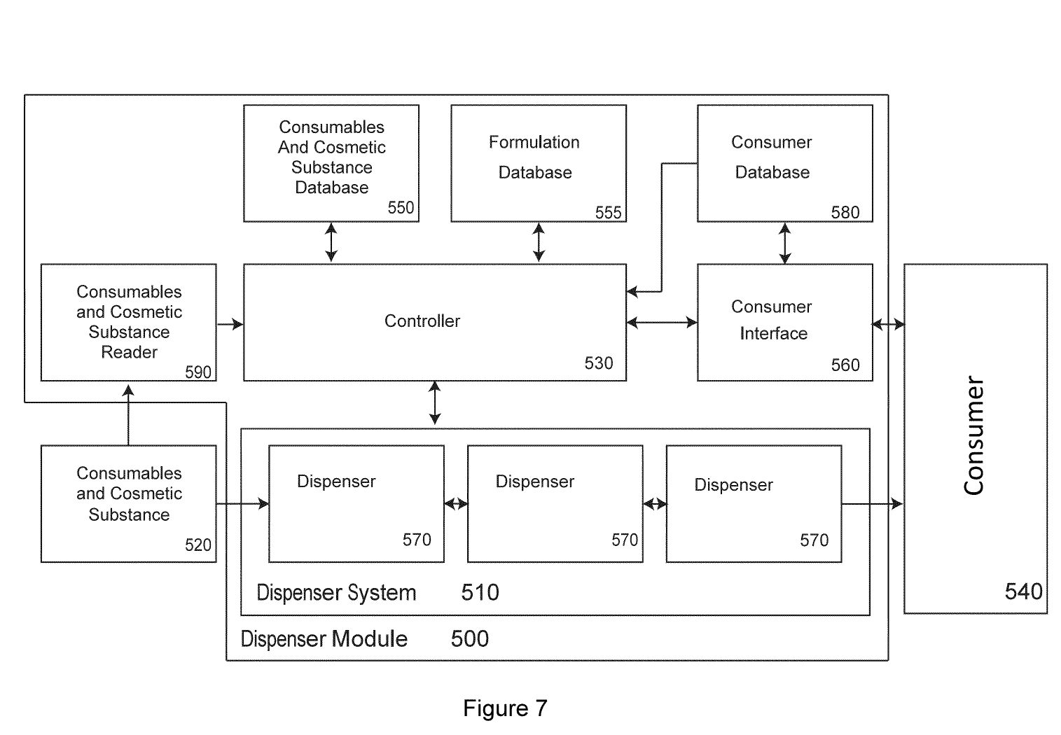

FIG. 7 shows another illustrative embodiment of dispensing module 500 as disclosed herein. Dispenser system 510 receives consumables and cosmetic substance 520 for dispensing to consumer 540. It is understood that dispenser system 510 may also function as a local storage environment for consumables and cosmetic substance 520 while contained therein. Controller 530 is operably connected to dispenser system 510. In fact, controller 530 may be integrated within dispenser system 510, or provided as a separate device communicating with dispenser system 510. Further, controller 530 directly or indirectly communicates with consumables and cosmetic substance database 550, formulation database 555, and consumer database 580.

It is important to note that while FIG. 7 shows consumables and cosmetic substance database 550, formulation database 555, and consumer database 580 as part of the dispensing module 500, they are in no way limited to this interpretation. It is understood that this convention is only one way of illustrating the inventions described herein, and it is further understood that this is in no way limiting to the scope of the inventions herein disclosed. For example, any of consumables and cosmetic substance database 550, formulation database 555, and consumer database 580 can be contained within information module 100, dispensing module 500, or elsewhere.

Controller 530 may additionally receive information from dispenser system 510 related to a ΔE or corresponding residual efficacy value of consumables and cosmetic substance 520 contained therein, including, but not limited to, information related to the storage conditions of the consumables and cosmetic substance therein, or information related to a condition of the consumables and cosmetic substance therein. For example, dispenser system 510 may also measure or sense information about the dispenser system's 510 storage environment during storage of the consumables and cosmetic substance 520 therein, and provide such information to controller 530, so that such information could also be provided to the consumables and cosmetic substance database 550 and additionally to the consumer 540 via consumer interface 560. Additionally, the controller 530 may receive information from the consumer via consumer interface 560 regarding observed or measured changes in the efficacy values of the consumables and cosmetic substances in dispenser system 510.

In a preferred embodiment of the present invention, controller 530 organizes and correlates the information it receives regarding consumables and cosmetic substance 520 from the various sources of such information, including consumables and cosmetic substance 520, consumables and cosmetic substance database 550, formulation database 555, consumer database 580, dispenser system 510, and consumer 540, and presents such information through consumer interface 560 to consumer 540 in a manner useful to consumer 540. For example, such information may be provided in a manner that assists consumer 540 in understanding how a consumables and cosmetic substance 520 meets the consumer's 540 needs. It could organize information regarding the consumables and cosmetic substance 520 to track consumer's 540 blood pressure reduction program, progress toward resolving dry skin, arthritic pain management program, and so forth. Controller 530 could have access to, or maintain, information regarding consumer 540, so as to track and assist consumer 540 in meeting their specific consumables and cosmetic needs. Access to such information may include, but is not limited to: direct input by the consumer through consumer interface 560; a consumer profile or database stored by controller 530; formulation database 555, consumer database 580, or any combination thereof.

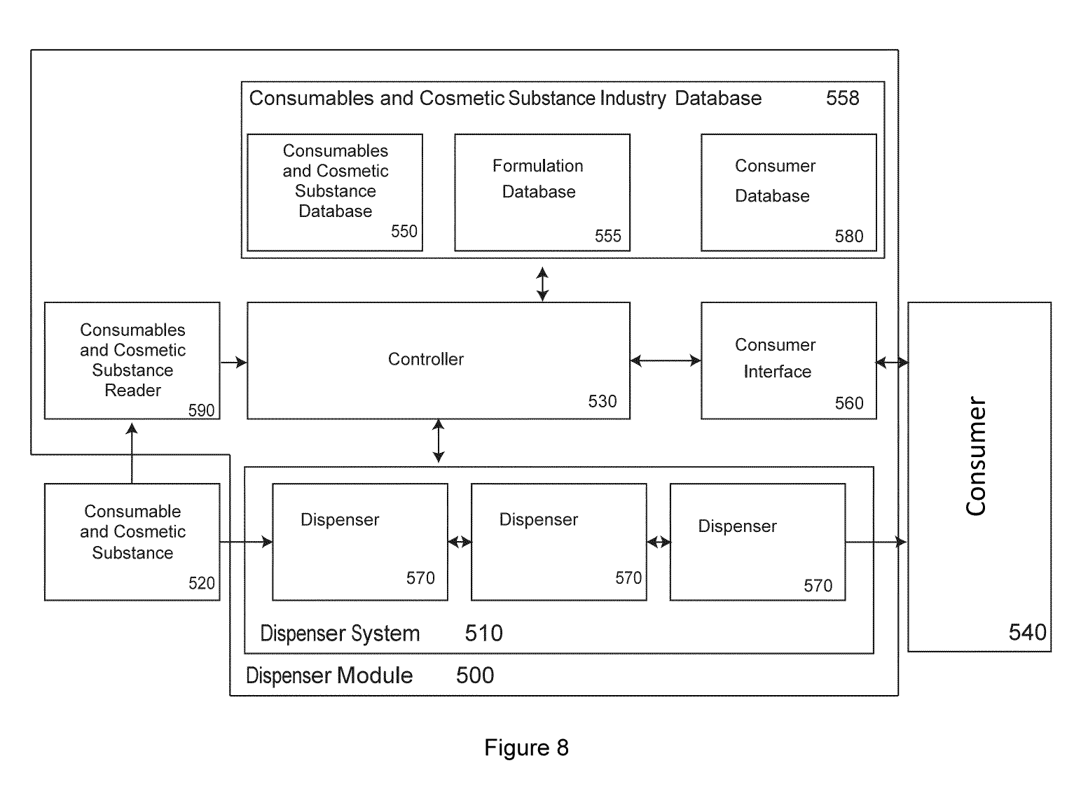

FIG. 8 shows another illustrative embodiment of dispensing module 500 as disclosed herein. Dispenser system 510 receives consumables and cosmetic substance 520 for dispensing to consumer 540. It is understood that dispenser system 510 may also function as a local storage environment for consumables and cosmetic substance 520 while contained therein. Controller 530 is operably connected to dispenser system 510. In fact, controller 530 may be integrated within dispenser system 510, or provided as a separate device communicating with dispenser system 510. Further, controller 530 communicates with consumables and cosmetic substance industry database 558 wherein consumables and cosmetic substance database 550, formulation database 555, and consumer database 580 are contained.

It is important to note that while FIG. 8 shows consumables and cosmetic substance database 550 as part of consumables and cosmetic substance industry database 558, and further shows consumables and cosmetic substance industry database 558 as part of the dispensing module 500, they are in no way limited to this interpretation. It is understood that this convention is only one way of illustrating the inventions described herein, and it is further understood that this is in no way limiting to the scope of the inventions herein disclosed. The same is understood for formulation database 555 and consumer database 580. For example, any of consumables and cosmetic substance database 550, formulation database 555, consumer database 580, and consumables and cosmetic substance industry database 558 can be contained within information module 100, dispensing module 500, or elsewhere.

Consumer interface 560 can be implemented as a display device mounted on controller 530, dispenser system 510, or dispenser 570. However, consumer interface 560 is preferably a tablet computer, personal computer, personal assistant, or smart phone, running appropriate software, such as an application, and communicating with controller 530.

While dispensing module 500 can be located in the consumer's home, dispensing module 500 may be located at a spa, hospital, hair salon, or any other service establishment for use in preparing and delivering consumables and cosmetic substances 520 for consumers who patronize such an establishment. Additionally, dispensing module 500 could be located at a consumables and cosmetic substance seller such as a grocery store, pharmacy, or health food store for preparation of consumables and cosmetic substances 520 purchased by consumers at such an establishment. It could be foreseen that dispenser modules 500 could become standalone businesses where consumers select consumables and cosmetic substances for preparation at the establishment or removal from the establishment for consumption elsewhere.

In another illustrative embodiment, dispenser system 510 may receive multiple consumables and cosmetic substance ingredients to be dispensed as a single consumables and cosmetic substance comprising the multiple ingredients. Controller 530 is operably connected to dispenser system 510, or 530 may be integrated within dispenser system 510 device. When dispenser system 510 receives consumables and cosmetic substance ingredients for dispensing, one or more consumables and cosmetic substance readers 590 scans the ingredients to obtain a dynamic information identifier and provides it to controller 530, allowing retrieval of the information about consumables and cosmetic substance ingredients from consumables and cosmetic substance database 550.

In an example, dispenser system 510 comprises dispenser 570, a dispensing machine used at a compounding pharmacy which performs a number of operations to adaptively dispense consumables and cosmetic substance 520, in this case, a suspension medication. Dispenser 570 could be a combination dispensing machine comprising: a precision weight dispenser for dry powder medicament substances; and an electric syringe pump for dispensing precision volumes of a liquid suspension. Controller 530 could operate dispenser 570 to execute an adaptive dispensing sequence to provide consumables and cosmetic substance 520 responsive to: the current efficacy value of a desired medicament; a prescribed efficacy content per dose of suspension medication; and a prescribed total amount of efficacy content.

In this example, consumables and cosmetic substance 520 is described by a consumer's prescription for a medicament “A”. The prescription was written by the consumer's physician, and calls for 50 mg of medicament A's efficacy content per dose, taken 3 times per day for 7 days. The consumer is informed by his physician that the prescription is typically compounded, and can be filled by a nearby compounding pharmacy. At the compounding pharmacy, the pharmacist reviews the consumer's prescription for medicament A, and quickly recognizes it as something that is provided to the consumer as a medicament suspension and decides to use the combination dispensing machine to prepare the corresponding suspension of medicament A.

The pharmacist retrieves a container of medicament A dry powder, removes the lid and places it into a medicament receiver of the combination dispensing machine. A scanner in the medicament receiver scans a dynamic information identifier on the container. The combination dispensing machine controller can now identify the contents and ΔE information corresponding to the scanned container by communicating with the consumables and cosmetic substance database 550. It is determined that the container contains medicament A and its efficacy value has degraded by 20%, and therefore its current residual efficacy value is 80%, as compared to its initial efficacy value. Medicament A is very expensive to manufacture and store, and although its efficacy value has degraded, knowledge of its current residual efficacy value is particularly useful, as it enables adaptive dispensing of the prescribed amount of efficacy content. The menu panel of the combination dispensing machine notifies the pharmacist “medicament A”, and prompts “desired efficacy content/dose”, and the pharmacist enters “50 mg”. The menu panel prompts “dosage frequency” and the pharmacist selects “3 times per day”. The menu panel prompts “treatment duration” and the pharmacist selects “7 days”. The controller can now dynamically determine the amount of medicament A required to comply with the prescription. The amount of medicament A is calculated as follows: (50 mg efficacy content/dose*3 dose/day*7 day)*(1 mg medicament A/0.80 mg efficacy content)=1312.5 mg medicament A.

The pharmacist now retrieves a prefilled syringe of suspension fluid and places it into a suspension syringe receiver of the combination dispensing machine. This type of suspension fluid is formulated to be an inactive and stable ingredient for delivering medicaments via suspension, and its efficacy value is therefore expressed as 0% as long as it maintains its chemical stability, so as not to disrupt the efficacy value of medicaments it may be combined with. As the suspension fluid ages, and depending on its storage conditions, it can eventually lose its chemical stability and its efficacy value will no longer be 0%, which corresponds to the actual shelf life of the suspension. A scanner in the suspension syringe receiver scans a dynamic information identifier on the syringe and the controller can now identify the contents and ΔE information corresponding to the scanned syringe by communicating with the consumables and cosmetic substance database 550. It is determined that the syringe contains suspension fluid B, but the suspension fluid's efficacy value is not 0% and that it has therefore expired. The pharmacist is alerted by the menu panel and he selects another syringe of suspension fluid, places it into the syringe receiver, and determines that it is suspension fluid B, its efficacy value is the desired 0% and accordingly it has not expired. The menu panel notifies the pharmacist “suspension fluid B” and prompts “dose volume” to determine the desired size of a single dose. In order to provide a user friendly regimen for the consumer to follow when dispensing the medicament suspension at home, the pharmacist wants to create a suspension with a concentration of 10 mg efficacy content per ml of medicament suspension, and provide the consumer with instructions to take a 5 ml dose 3 times per day. The pharmacist selects “5 ml”. The controller can now determine the amount of suspension fluid B required to comply with the prescription. The amount of suspension fluid B is calculated as follows: (5 ml/dose*3 dose/day*7 day)=105 ml suspension fluid B.

The combination dispensing machine now prompts the pharmacist “105 ml of suspension medicament will be dispensed. Place 250 ml bottle in delivery receptacle.” The pharmacist places a 250 ml bottle in the delivery receptacle, selects “dispense”, and the combination dispensing machine adaptively dispenses 1312.5 mg of medicament A and 105 ml of suspension fluid B to provide a medicament suspension responsive to the ΔE information and corresponding residual efficacy value for medicament A and suspension fluid B, input from the physician's prescription, and input from the pharmacist. The combination dispensing machine also prints a label to be placed on the 250 ml bottle of medicament suspension. The information on the label may indicate the contents of the bottle, medicament concentration expressed as efficacy content/ml, dose size, dose frequency, and other basic information. Further, the information on the label may include the dynamic information identifier of suspension fluid B or medicament A, and may additionally, or alternatively, include a new dynamic information identifier unique to the adaptively dispensed medicament suspension, wherein such a new dynamic information identifier may be created by the consumables and cosmetic substance database 550.

Alternatively, dispenser system 510 could be composed of a plurality of individual dispensers 570 and an adaptive dispensing controller comprising cosmetic substance reader 590, consumer interface 560, and controller 530. While an automated system would be optimal, dispenser system 510 could be operated manually by consumer 540 from instructions provided by the controller 530 to consumer interface 560. In this embodiment, controller 530 could provide consumer 540 with instructions as to each step in an adaptive dispensing protocol. In the example of the prescription for medicament A, the pharmacist could use the adaptive dispensing controller to scan the dynamic information identifiers of corresponding containers of medicament A and suspension fluid B. The adaptive dispensing controller could communicate with consumables and cosmetic substance database 550 to determine the identity of particular medicament and suspension substances contained therein and their corresponding ΔE information and residual efficacy value. The adaptive dispensing controller could then instruct the pharmacist to adaptively dispense 1312.5 mg of medicament A and 105 ml of suspension fluid B into a 250 ml bottle, responsive to the ΔE information and corresponding residual efficacy value for medicament A and suspension fluid B, input from the physician's prescription, and input from the pharmacist. Dispensing the specified quantities of medicament A and suspension fluid B could be accomplished in any known fashion, such as using weight scales, graduated beakers, etc. The adaptive dispensing controller may print a label to be placed on the bottle of medicament suspension, or alternatively, communicate directly or indirectly with a printer to print the label. The information on the label may indicate the contents of the bottle, medicament concentration expressed as efficacy content/ml, dose size, dose frequency, and other basic information. Further, the information on the label may include the dynamic information identifier of suspension fluid B or medicament A, and may additionally, or alternatively, include a new dynamic information identifier unique to the adaptively dispense medicament suspension, wherein such a new dynamic information identifier may be created by the consumables and cosmetic substance database 550.

In another example, dispenser system 510 could be composed of a plurality of individual dispensers 570 and a smartphone, tablet computer, or other handheld communication device running an appropriate application, wherein the smartphone, tablet computer, or other handheld communication device comprises the cosmetic substance reader 590, consumer interface 560, and controller 530. Such a dispenser system 510 could be operated manually by consumer 540 from instructions provided by the controller 530 to consumer interface 560. In this example, a smartphone running an appropriate application comprises the cosmetic substance reader 590, consumer interface 560, and controller 530. Accordingly, the smartphone could provide consumer 540 with instructions as to each step in an adaptive dispensing protocol. In the example of the prescription for medicament A, the pharmacist could use a camera on the smartphone to scan the dynamic information identifiers of corresponding containers of medicament A and suspension fluid B. The smartphone could communicate with consumables and cosmetic substance database 550 to determine the identity of particular medicament and suspension substances contained therein and their corresponding ΔE information and residual efficacy value. The smartphone could then instruct the pharmacist, such as through its screen, to adaptively dispense 1312.5 mg of medicament A and 105 ml of suspension fluid B into a 250 ml bottle, responsive to the ΔE information and corresponding residual efficacy value for medicament A and suspension fluid B, input from the physician's prescription, and input from the pharmacist. Dispensing the specified quantities of medicament A and suspension fluid B could be accomplished in any known fashion, such as using weight scales, graduated beakers, etc. The smartphone may communicate the information required for a label to be placed on the bottle of medicament suspension, or may send the information directly to a printer to print a label to be placed on the bottle of medicament suspension. The information on the label may indicate the contents of the bottle, medicament concentration expressed efficacy content/ml, dose size, dose frequency, and other basic information. Further, the information on the label may include the dynamic information identifier of suspension fluid B or medicament A, and may additionally, or alternatively, include a new dynamic information identifier unique to the adaptively dispense medicament suspension, wherein such a new dynamic information identifier may be created by the consumables and cosmetic substance database 550.

As illustrated by the examples herein, consumables and cosmetic substances can be adaptively dispensed by dispenser system 510 responsive to a ΔE and corresponding residual efficacy value of the corresponding consumables and cosmetic substance. Dispenser system controller 530 uses consumables and cosmetic substance information retrieved by consumables and cosmetic substance reader 590 from consumables and cosmetic substance 520, or preferably retrieved from consumables and cosmetic substance database 550 using reference information comprising a dynamic information identifier read by reader 590 from substance 520, to dynamically modify dispensing parameters in order to maintain or otherwise optimize efficacy content of an adaptively dispensed consumables and cosmetic substance 520. Additionally, dynamically modified dispensing parameters could be determined for a variety of different dispenser systems 510, or dispensers 570, and controller 530 could select the corresponding dynamically modified dispensing instructions. Controller 530 may further dynamically operate dispenser system 510 to adaptively dispense consumables and cosmetic substance 520 without consumer intervention.

In a further embodiment of the present invention, consumables and cosmetic substance reader 590 and/or dispenser system 510 measures or senses information regarding the current state of consumables and cosmetic substance 520 and provides such information to controller 530 to allow controller 530 to dynamically modify operation of dispenser system 510.

As illustrated by the examples herein, a consumables and cosmetic substance can be adaptively dispensed by dispenser system 510 responsive to a consumer's input regarding the consumables and cosmetic substance. For instance, in the example of dispensing medicament A in the form of a medicament suspension, the adaptive dispensing was responsive to consumer input provided in the form of the physician requiring 50 mg efficacy content/dose and in the form of the pharmacist specifying a dose volume of 5 ml.

The consumer's input regarding consumables and cosmetic substance may include needs related to ΔE and corresponding residual efficacy values, or may include particular needs or exclusions regarding origin and creation of consumables and cosmetic substances. With such input provided by consumer 540 to controller 530 through consumer interface 560, or provided by consumer database 580, controller 530 can dynamically modify operation of dispenser system 510 responsive to the consumer input and provide a consumables and cosmetic substance according to the consumer's desires. For example, the consumer may provide input that he is allergic to shellfish, therefore excluding iodine-based or shellfish derived consumables and cosmetic substances. This input may trigger the consumer interface 560 to alert the consumer that an iodine-based antiseptic, corresponding to a scanned dynamic information identifier, does not meet the consumer's needs, and prevent the consumer from dispensing it. This input may trigger the consumer interface 560 to alert a nurse that a Calcium supplement made from clam shells, corresponding to a scanned dynamic information identifier, does not meet the consumer's needs, and prevent the nurse from dispensing it. This input may trigger the consumer interface 560 to alert the consumer that a cosmetic product containing Krill oil, corresponding to a scanned dynamic information identifier, does not meet the consumer's needs, and prevent the consumer from purchasing it. In another example, the consumer may provide input that he wants only organic consumables and cosmetic substances. This input may trigger the consumer interface 560 to notify the consumer that a Vitamin C supplement derived from organic sources, corresponding to a scanned dynamic information identifier, meets the consumer's needs. Alternatively, it might trigger the consumer interface 560 to alert the consumer that a cosmetic product containing chemically manufactured Vitamin C, corresponding to a scanned dynamic information identifier, does not meet the consumer's needs, and prevent the consumer from purchasing it.

As illustrated by the examples herein, a consumables and cosmetic substance can be adaptively dispensed by dispenser system 510 responsive to a ΔE and corresponding residual efficacy value of the corresponding consumables and cosmetic substance, and a consumer's input regarding the consumables and cosmetic substance. For instance, in the example of dispensing medicament A in the form of a medicament suspension, the adaptive dispensing was responsive to ΔE and corresponding residual efficacy values for medicament A and suspension fluid B retrieved from consumables and cosmetic substance database 550 and consumer input provided in the form of the physician requiring 50 mg efficacy content/dose and the pharmacist specifying a dose volume of 5 ml.

In a further embodiment, controller 530 receives origin and creation information regarding the consumables and cosmetic substance 520, ΔE and corresponding residual efficacy values regarding the consumables and cosmetic substance 520, and input regarding the consumer's consumables and cosmetic substance needs or desires, and dynamically modifies operation of dispenser system 510 responsive to the origin and creation information, ΔE and corresponding residual efficacy values, and consumer input, so as to provide a consumables and cosmetic substance according to the consumer's needs.

Dispenser system 510 can prepare a consumables and cosmetic substance for consumer 540 which contains a plurality of consumables and cosmetic substances 520. Dispensing module 500 includes formulation database 555 which is operably connected to controller 530. Formulation database 555 can be part of, but is not limited to, consumables and cosmetic substance industry database 558, consumables and cosmetic substance database 550, or it can be a stand-alone database. While formulation database 555 can be located locally, it is preferably accessible to many dispenser modules 500 through a telecommunications system such as the internet, including wireless telecommunications systems.

Controller 530 is also preferably connected to consumer database 580. Consumer database 580 may be additionally connected to consumer interface 560. Consumer database 580 could include consumer's 540 efficacy content and consumables and cosmetic substance needs and preferences, and could be in the form of a consumer profile custom tailored to an individual consumer or selected from a menu of consumer profiles. Consumer database 580 may receive input regarding consumer 540 from consumer 540, but could also include information supplied by consumer's 540 medical records, exercise records from the consumer's gym, and other information sources. Consumer database 580 could include information regarding regulatory actions and/or manufacturer warnings or recalls of consumables and cosmetic substances which may be obtained, have been obtained, or may be dispensed or consumed by the consumer. Additionally, consumer database 580 could include information regarding consumer's 540 preferences provided by controller 530 for previous consumables and cosmetic substance 520 dispensings. Finally, consumer database 580 could include consumer preferences from external sources such as, but not limited to, physician's offices, pharmacies, and retail stores where consumer 540 purchases consumables and cosmetic substances 520. Finally, consumer database 580 could include information from consumer module 600.

Consumer database 580 could be a local database maintained by controller 530 or consumer interface 560. Preferably, consumer database 580 is part of a consumables and cosmetic substance industry database 558 containing such information regarding a plurality of consumers 540.

In an embodiment, controller 530 can operate to identify desired consumables and cosmetic substances 520. In operation, consumer 540 could select from a menu of consumables and cosmetic substances using consumer interface 560. The consumer 540 may select a specific type of substance from a database, for example from consumer database 580 or from a database stored by the controller 530, such as “organic bath soaps”. Controller 530 could present a list of candidate organic bath soaps to the consumer 540 through consumer interface 560. The consumer could select a particular organic bath soap, add it to a list, and choose a new search category, such as “organic Vitamins”. Controller 530 could present a list of candidate organic Vitamins to the consumer 540 through consumer interface 560 and the consumer could add selected items to the list. Further, controller 530 could transmit the consumer's list of selections to a consumables and cosmetic substance retailer, so consumer 540 could pick up the items or could have the items delivered.

Consumables and cosmetic substance 420 could be a plurality of consumables and cosmetic substance ingredients. In an embodiment, controller 530 can operate to select the necessary ingredients to dispense such a consumables and cosmetic substance 420. In operation, consumer 540 could select from a formulation database 555 using a formulation menu provided by consumer interface 560. The consumer 540 may select a specific formulation from formulation database 555 or could select a formulation category within database 555, such as “organic bath soap formulations”. The consumer could select a desired formulation and the controller 530 could prepare a shopping list for consumer 540, such as through consumer interface 560. Further, controller 530 could transmit the shopping list to a consumables and cosmetic substance retailer, so consumer 540 could pick up such items already selected or could have such items delivered.

Alternatively, if instructed by consumer 540 to utilize consumables and cosmetic substances on hand, which have been logged into controller 530 through consumables and cosmetic substance reader 590, controller 530 could modify or suggest a formulation that used only consumables and cosmetic substances 520 available to dispensing module 500. For example, if consumer 540 instructs dispensing module 500 through dispenser interface 560 that consumer 540 would like to make organic bath soap utilizing consumables and cosmetic substance ingredients on hand, controller 530 would utilize information in various databases to which it has access regarding formulations for such a soap. In this case, controller 530 would match its inventory of available consumables and cosmetic substance ingredients with formulations for organic bath soap in formulation database 555 and find candidate formulations. Controller 530 could present various formulation options to consumer 540 using consumer interface 560, highlighting features of each available formulation from the standpoint of consumer's 540 consumables and cosmetic substance needs and/or preferences. In a preferred embodiment, controller 530 could select a formulation that optimized the consumer's 540 needs and preferences and adaptively dispense it using dispenser system 510.

Consumables and cosmetic substance database 550, formulation database 555, and consumer database 580 may be part of consumables and cosmetic substance industry database 558, as shown in FIG. 8. Controller 530 would communicate with such a consumables and cosmetic substance industry database 558 through a communication system such as the internet, and preferably a telecommunications system such as wireless telecommunications. In such an arrangement, controller 530 could even verify that local supermarkets have the items in stock, retrieve and transmit a route to get to the supermarket from the consumer's current location, and further retrieve and transmit a route to follow within the supermarket to efficiently obtain the items.

In an embodiment of the present invention, a consumer wishing to dispense a consumables and cosmetic substance with an adaptive dispensing appliance can determine the current residual efficacy value of the consumables and cosmetic substance, and knowingly affect the actual efficacy content of the dispensed amount. To do so, the consumer would scan a dynamic information identifier provided with the consumables and cosmetic substance using a scanner of, or communicating with, the dispensing appliance. This enables the dispensing appliance's controller to retrieve, from the consumables and cosmetic substance industry database, information related to changes in efficacy values, ΔE information, referenced to the dynamic information identifier. Thereafter, the dispensing appliance controller can request and receive input from the consumer by providing options for the consumer to choose from through a consumer interface, also referred to herein as a dynamic consumables and cosmetic substance menu panel, which may be a panel, screen, keyboard, or any known type of user interface. The dynamic consumables and cosmetic substance menu panel provides the consumer with the ability to input the desired end results for the efficacy content that will be dispensed, such as by choosing among different possible end results offered by the dynamic consumables and cosmetic substance menu panel. The controller then creates, or retrieves from the consumables and cosmetic substance industry database, adaptive dispensing parameters that are responsive to: the ΔE information retrieved from the consumables and cosmetic substance industry database using the dynamic information identifier; and the consumer input obtained through the dynamic consumables and cosmetic substance menu panel. These adaptive dispensing parameters, also referred to herein as an adaptive dispensing sequence, are then communicated to the consumer for implementation through the dynamic consumables and cosmetic substance menu panel, or alternatively, automatically implemented by the controller.

For example, the consumer is ready to dispense a skin lotion using an automated dispensing appliance, such an automated pump that delivers precise volumes of liquid. The consumer first uses the dispensing appliance's scanner to scan the dynamic information identifier provided with the skin lotion. The dynamic information identifier may be an optically readable label, an RFID tag, or any other known format compatible with the dispensing appliance's scanner, attached to, or incorporated into, the consumables and cosmetic substance or its packaging. The dispensing appliance controller then retrieves ΔE information referenced to the dynamic information identifier from the consumables and cosmetic substance industry database. The dispensing appliance's controller additionally requests input from the consumer regarding the desired efficacy content of the skin lotion to be dispensed, by providing options for the consumer to choose from through its dynamic consumables and cosmetic substance menu panel. It is understood that these options may be presented in any known fashion, and while particular presentation forms will be discussed herein, they are in no way limiting. In this example, the dynamic consumables and cosmetic substance menu panel presents options for the consumer to choose from in a format similar to the options provided by routing and navigation applications (i.e. “shortest distance”, “shortest time”, “least freeway travel”, and so forth). For instance, the options provided by the dynamic consumables and cosmetic substance menu panel may be “normal skin”, “dry skin”, and “very dry skin”. The consumer can find out more detailed information regarding the efficacy content that will be delivered by a particular option by selecting that option, whereupon the dynamic consumables and cosmetic substance menu panel will provide a summary of useful information, such as, but not limited to, the volume of lotion that will be adaptively dispensed by selecting an option and the corresponding therapeutic benefit. The consumer may further be provided with other useful information, such as, but not limited to, the current degradation of efficacy value of the lotion in the dispensing appliance, for example, presented as a dynamic efficacy value table, which may express degradation as a percentage of initial efficacy value. If the consumer determines that he is not pleased with his selection based upon the more detailed information provided through the dynamic consumables and cosmetic substance menu panel, he can return to the previous screen and choose another option. The consumer can continue to select options and review the more detailed information until he determines that an option meets his requirements. Upon determining that an option meets his needs, particularly needs related to the information about residual efficacy content of the dispensed amount, the consumer proceeds with the option using the dynamic consumables and cosmetic substance menu panel, such as by selecting “proceed”. The dispensing appliance controller then implements the adaptive dispensing sequence, that is, the adaptive dispensing parameters that are responsive to: the ΔE information it has retrieved from the consumables and cosmetic substance industry database using the dynamic information identifier provided with the skin lotion; and the consumer input obtained through the dynamic consumables and cosmetic substance menu panel. The adaptive dispensing sequence assures that the consumer will be provided with an amount of skin lotion that meets his needs, particularly his needs related to residual efficacy content of the dispensed skin lotion.

In one example of the present invention, the consumer wishing to dispense the skin lotion selects the “normal skin” option on the dynamic consumables and cosmetic substance menu panel. The dynamic consumables and cosmetic substance menu panel then provides the consumer with a summary of the residual efficacy content that will result from adaptively dispensing the skin lotion with a corresponding adaptive dispensing sequence, and additionally describes the corresponding volume of lotion and therapeutic benefit. The consumer is also able to determine from the consumables and cosmetic substance dynamic efficacy value table that the skin lotion scanned has experienced a ΔE of 12%, and has a residual efficacy value of 88% of its initial efficacy value. It is understood that the consumables and cosmetic substance dynamic efficacy value table may provide any number of individual residual efficacy values, such as residual collagen value, residual phytochemical value, and so forth. It is also understood that residual efficacy value may be provided as an aggregated value based on several independent residual efficacy values. The consumer is satisfied with the “normal skin” option and selects “proceed” on the dynamic consumables and cosmetic substance menu panel. The dispensing appliance can now instruct the consumer through its dynamic consumables and cosmetic substance menu panel on the various settings and requirements to adaptively dispense the skin lotion according to the adaptive dispensing sequence. Alternatively, the dispensing appliance's controller can automatically implement the adaptive dispensing sequence.

On another day, the same consumer is again going to dispense the skin lotion with his dispensing appliance. He remembers that the last time he did, he wished it would have made his skin feel a little less dry. He scans the dynamic information identifier with the scanner on his dispensing appliance, or alternatively, it may be stored in the controller's memory. The controller retrieves ΔE information referenced to the dynamic information identifier from the consumables and cosmetic substance industry database and additionally requests input from the consumer regarding the desired residual efficacy content of the skin lotion following dispensing, by providing the options “normal skin”, “dry skin”, and “very dry skin”. The consumer selects the “dry skin” option from the dynamic consumables and cosmetic substance menu panel. The dynamic consumables and cosmetic substance menu panel then provides the consumer with a summary of the residual efficacy content that will result from adaptively dispensing the skin lotion with a corresponding adaptive dispensing sequence, and additionally describes the corresponding volume of lotion and therapeutic benefit. The consumer is also able to determine from the consumables and cosmetic substance dynamic efficacy value table that the skin lotion scanned has experienced a ΔE of 14%, and has a residual efficacy value of 86% of its initial efficacy value. This information confirms to the consumer that he is indeed benefiting from knowing ΔE information regarding the skin lotion, because he knows that his dispensing appliance will adaptively deliver the skin lotion responsive to the ΔE information and his needs. The consumer is satisfied with the “dry skin” option and selects “proceed” on the dynamic consumables and cosmetic substance menu panel. The dispensing appliance can now instruct the consumer through its dynamic consumables and cosmetic substance menu panel on the various settings and requirements to adaptively dispense the skin lotion according to the adaptive dispensing sequence. Alternatively, the dispensing appliance's controller can automatically implement the adaptive dispensing sequence.

On still another day, the same consumer is again going to dispense the skin lotion with his dispensing appliance. He remembers that the last time he did, he selected the “dry skin” option, and although it helped, he still wished his skin felt less dry. He scans the dynamic information identifier with the scanner on his dispensing appliance, or alternatively, it may be stored in the controller's memory. The controller retrieves ΔE information referenced to the dynamic information identifier from the consumables and cosmetic substance industry database and additionally requests input from the consumer regarding the desired residual efficacy content of the skin lotion following dispensing, by providing the options “normal skin”, “dry skin”, and “very dry skin”. The consumer selects the “very dry skin” option from the dynamic consumables and cosmetic substance menu panel. The dynamic consumables and cosmetic substance menu panel then provides the consumer with a summary of the residual efficacy content that will result from adaptively dispensing the skin lotion with a corresponding adaptive dispensing sequence, and additionally describes the corresponding volume of lotion and therapeutic benefit. The consumer is also able to determine from the dynamic efficacy value table that the skin lotion scanned has experienced a ΔE of 24%, and has a residual efficacy value of 76% of its initial efficacy value. This information again confirms to the consumer that he is indeed benefiting from knowing ΔE information regarding the skin lotion, because he knows that his dispensing appliance will adaptively deliver the skin lotion responsive to the ΔE information and his needs. The consumer is satisfied with the “very dry skin” option and selects “proceed” on the dynamic consumables and cosmetic substance menu panel. The dispensing appliance can now instruct the consumer through its dynamic consumables and cosmetic substance menu panel on the various settings and requirements to adaptively dispense the skin lotion according to the adaptive dispensing sequence. Alternatively, the dispensing appliance's controller can automatically implement the adaptive dispensing sequence.

On yet another day, the same consumer is again going to dispense the skin lotion with his dispensing appliance. He is happy with the results he has obtained by selecting the “very dry skin” option. He scans the dynamic information identifier with the scanner on his dispensing appliance, or alternatively, it may be stored in the controller's memory. The controller retrieves ΔE information referenced to the dynamic information identifier from the consumables and cosmetic substance industry database, but this time, the menu panel does not request input from the consumer regarding the desired residual efficacy content of the skin lotion following dispensing, by providing the options “normal skin”, “dry skin”, and “very dry skin” Instead, the menu panel alerts the consumer that the skin lotion has expired, based on information from the dynamic efficacy value table, and further presents the table on the menu panel. In this example, the skin lotion has determined that the minimum acceptable residual efficacy value is 70%, and the skin lotion's current residual efficacy value has fallen to 67%. This information again confirms to the consumer that he is indeed benefiting from knowing ΔE information regarding the skin lotion, because he has been prevented from using a product wherein the efficacy value had expired. The consumer removes the expired skin lotion canister or bag from the dispensing appliance, replaces it with a new one, and proceeds as usual, selecting the “very dry skin” option.

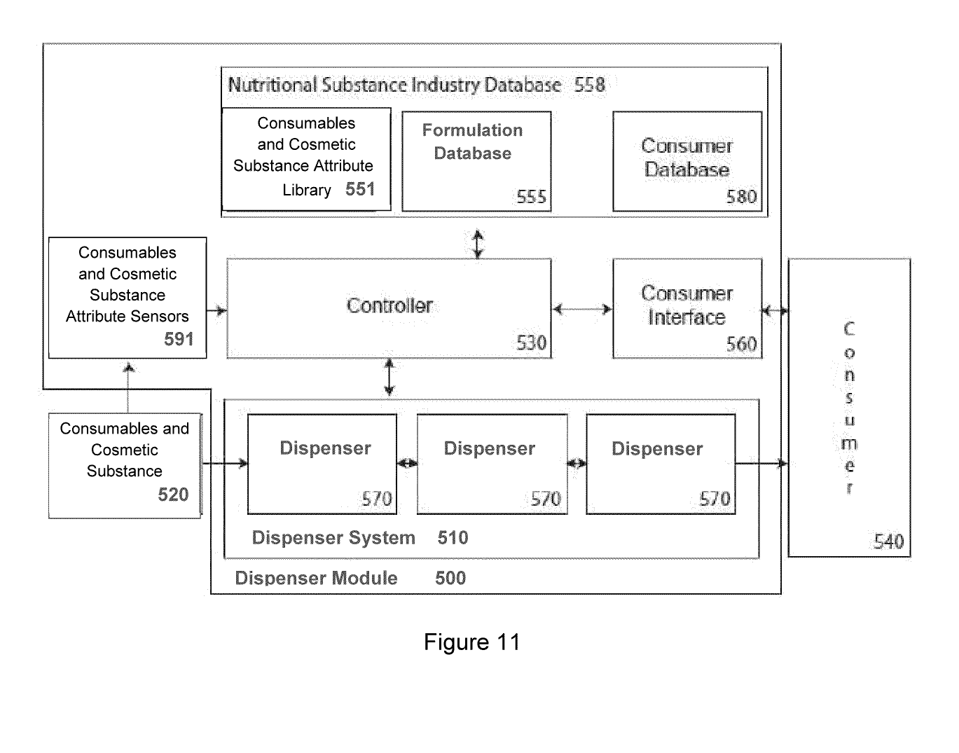

FIG. 11 shows an alternate embodiment of a dispenser module, wherein a dispenser, also referred to herein as a dispensing appliance, may have features enabling it to collect data and communicate the data with an alternate database that facilitates identification of a consumables and cosmetic substance to be dispensed. Such features may include, but are not limited to, sensors capable of measuring and collecting data regarding visual appearance, smell, volatiles, texture, touch, sound, chemical composition, temperature, weight, volume, density, hardness, viscosity, surface tension, and any other known physical attributes of the consumables and cosmetic substance, and are also referred to herein as consumables and cosmetic substance attribute sensors. These may include, but are not limited to, optical sensors, laser sensors, cameras, electric noses, microphones, olfactory sensors, surface topography measurement equipment, three dimensional measuring equipment, chemical assays, hardness measuring equipment, ultrasound equipment, impedance detectors, temperature measuring equipment, weight measurement equipment, and any known sensor capable of providing data regarding a physical attribute of a consumables and cosmetic substance. For example, an electronic tagging system, such as the tagging system manufactured by Kovio of San Jose, Calif., USA, can be used not only for tracking consumables and cosmetic substances, but can include components to measure attributes of consumables and cosmetic substances, and record and transmit such information. The alternate database would consist of a massive library 551 of sensed attribute data corresponding to known consumables and cosmetic substances in known efficacy states, and is herein referred to as the consumables and cosmetic substance attribute library.

Still other examples of sensor technology that might be utilized as a consumables and cosmetic substance attribute sensor include, but are not limited to: Surface plasmon resonance sensors (SPR) such as a cell phone based sensor platform disclosed by Preechaburana et at, Angew. Chem. Int. Ed. 2012,51,11585-11588, “Surface plasmon resonance chemical sensing on cell phones”; SPR sensors such as those disclosed by Zhang, et al, Zhejiang University, Hangzhou 310058, P.R. China “Detection of penicillin via surface plasmon resonance biosensor”; the combination of microfluidics with Lab-on-a-Chip and Lab-on-a-Foil solutions disclosed by Focke, et al, www.rsc.org/loc, 19 Mar. 2010, “Lab-on-a-Foil: microfluidics on thin and flexible films”; Localized surface plasmon response sensors (LSPR) such as those disclosed by Roche, et al, Journal of Sensors, volume 2011, article ID 406425, doi: 10.1155/2011/406425, “A camera phone localized surface plasmon biosensing platform towards low-cost label-free diagnostic testing”; printed sensors such as those available from Thin Film Electronics ASA, for example the Thinfilm Time-Temperature Sensor; wireless pH sensors such as those discussed in IEE Sensors Journal, Vol 12, No. 3, March 2012 487 “A passive radio-frequency pH sensing tag for wireless food quality monitoring”; sensing of biological quantities such as that discussed in Appl Microbiol Biotechnol (2013) 97:1829-1840 “An overview of transducers as platform for the rapid detection of foodborne pathogens”; cell phone based E. Coli sensor using florescent imaging to detect bacteria in food and water, developed at UCLA Henry Samueli School of Engineering and Applied Science; sensors discussed in Journal of Food Engineering 100 (2010) 377-387 “Biomimetric-based odor and taste sensing systems to food quality and safety characterization: An overview on basic principles and recent achievements”; sensors discussed in Sensors 2010, 10, 3411-3443, doi 10.3390/s100403411 “Advanced Taste Sensors Based on Artificial Lipids with Global Selectivity to Basic Taste Qualities and High Correlation to Sensory Scores”; sensing described in Chem. Sci., 2012, 3, 2542 “Fluorescent DNAs printed on paper: sensing food spoilage and ripening in the vapor phase”; the use of a Silicon Integrated Spectrometer to sense food for ripeness and other qualities is described in IEEE Photonics Journal, 1 (4), p. 225-235 (2009); numerous sensing techniques described in analytica chima acta 605 (2007) 111-129 “A review on novel developments and applications of immunosensors in food analysis”; numerous sensing techniques described in J. Biophotonics 5, No. 7, 483-501 (2012)/doi 10.1002/jbio.201200015 “Surface plasmon resonance based biosensor technique: A review”; LSPR techniques to sense bitterness of tea described in Agric. Food Chem., 2010, 58 (14), pp 8351-8356 “B-Cyclodextrin/Surface plasmon response detection system for sensing bitter astringent taste intensity of green tea catechins”; a review on nano-biosensors to measure tastes and odors discussed in Bio-Nanotechnology: A revolution in food biomedical and health sciences, first edition, 2013, John Wiley & Sons, Ltd. “Nano-Biosensors for mimicking gustatory and olfactory senses”; techniques described in Science Daily, http://www.sciencedaily.com/releases/2013/02/130214111612.htm, 14 Feb. 2013 “World's most sensitive plasmon resonance sensor inspired by the ancient roman cup”; ethylene sensors discussed in Anal. Chem., 2011, 83 (16), pp 6300-6307, doi: 10.1021/ac2009756 “Electrochemical sensing of ethylene employing a thin ionic-liquid layer”; multiplex SPR techniques described in Anal Bioanl Chem (2011) 400: 3005-3011, doi 10.1007/s00216-011-4973-8 “Imaging surface plasmon resonance for multiplex microassay sensing of mycotoxins”; a review of noble metal nono-optical sensors based on LSPR by Zhao, et al, “Localized surface plasmon resonance biosensors”; colorimetric plasmon resonance imaging described by Garda, et al, Advanced Optical Materials 2013, 1, 68-76, doi: 10.1002/adom.201200040 “Colorimetric plasmon resonance imaging using nano Lycurgus cup arrays”; sensor using multiplex fiber-optic biosensor implemented by integrating multiple particle plasmon resonances (PPRs), molecular bioassays, and microfluidics is disclosed by Lin, et al, Proc. SPIE 8351, Third Asia Pacific Optical Sensors Conference, 835125 (Jan. 31, 2012), doi: 10.117/12.914383 “Multiplex fiber-optic biosensor using multiple particle plasmon resonances”; sensor based on multilayered graphene SPR-based transmission disclosed by Kim, et al, J. Nonosci. Nanotechnol, 2012 July 12(7):5381-5 “Evaluation of multi-layered graphene surface plasmon resonance-based transmission type fiber optic sensor”. It is understood that sensors may be configured to perform multiple test assays in a single use to develop a multidimensional dataset from each use.

At this juncture it can be understood that an efficacy value of a consumables and cosmetic substance can be indicated by its olfactory values or its taste values. Typically, but not necessarily, olfactory values and taste values are detectable by the human sense of smell and taste. However, consumables and cosmetic substances may emit or produce gaseous components that are not detectable or discernible by the human sense of smell, or components not detectable or discernible by the human sense of taste, but, nevertheless, these components may be indicative of a particular efficacy state of the consumables and cosmetic substance. In addition, olfactory values and taste values can be indicative of adulteration of consumables and cosmetic substances, such as by spoilage, contamination, or substitution of other consumables and cosmetic substances.

It is understood that the utilization of the consumables and cosmetic substance attribute sensors can provide beneficial information regarding adulteration or mislabeling of consumables and cosmetic substances.

In an example of a dispensing appliance equipped with consumables and cosmetic substance attribute sensors, a consumer places a cartridge of injectable insulin medicament into an automated insulin delivery pump equipped with consumables and cosmetic substance attribute sensors. Upon purging the injection system with the liquid medicament inside of the cartridge, the insulin delivery pump is also able to sense the liquid medicament using its attribute sensors. The consumables and cosmetic substance attribute sensors collect a variety of physical attribute data from the liquid medicament. The insulin pump's controller then transmits the physical attribute value data collected to the consumables and cosmetic substance industry database, for comparison to the consumables and cosmetic substance attribute library 551 contained therein. It is understood that while FIG. 11 shows the consumables and cosmetic substance industry database as part of the dispenser module, it may reside in the information module. It is further understood that while the consumables and cosmetic substance attribute library is shown as part of the consumables and cosmetic substance industry database, this only for the purposes of example and not intended to be limiting in any way, and it may reside within the information module or may exist as an independent database. When a match is found for the physical attribute value data collected from the liquid medicament placed in the insulin pump, the consumables and cosmetic substance industry database can determine that the matching consumables and cosmetic substance attribute library 551 dataset corresponds to a porcine derived insulin medicament with known efficacy values. Thereafter, the insulin pump controller can acquire input from the consumer by providing options for the consumer to choose from through a consumer interface, also referred to herein as a dynamic consumables and cosmetic substance menu panel, which may be a panel, screen, keyboard, or any known type of user interface. Such options may include, but are not limited to, “Bolus”, which provides the consumer with the ability to input a desired dose that will be immediately dispensed, or “Baseline”, wherein the consumer input comprises the input obtained through monitoring his blood sugar and other relevant blood levels. The controller then creates, or retrieves from the consumables and cosmetic substance industry database, adaptive dispensing parameters that are responsive to: the efficacy value information retrieved from the consumables and cosmetic substance industry database using the consumables and cosmetic substance attribute library 551; and the consumer input obtained through the dynamic consumables and cosmetic substance menu panel and through monitoring the consumer's blood. These adaptive dispensing parameters, also referred to herein as adaptive dispensing sequence, are then automatically implemented by the controller.

In the above example, the consumer is ready to start insulin injection using an insulin pump equipped with consumables and cosmetic substance attribute sensors. The consumer places a cartridge of insulin into the insulin pump, where the pump's consumables and cosmetic substance attribute sensors sense various physical attribute data from the liquid medicament in the cartridge. The insulin pump's controller then transmits the sensed attribute value data to the consumables and cosmetic substance industry database for comparison to the consumables and cosmetic substance attribute library. The consumables and cosmetic substance industry database determines that the sensed data matches the consumables and cosmetic substance attribute library dataset corresponding to porcine derived insulin medicament having specific efficacy values. The consumer is notified of this determination. The dispensing appliance's controller additionally acquires input from the consumer through its dynamic consumables and cosmetic substance menu panel and through monitoring the consumer's blood. The consumer can find out more detailed information regarding the delivery of efficacy content that will result from a particular option by selecting that option, whereupon the dynamic consumables and cosmetic substance menu panel will provide a summary regarding the corresponding residual efficacy content to be delivered. The dynamic consumables and cosmetic substance menu panel may further provide other useful information, such as, but not limited to, the current residual efficacy value of the insulin medicament inside the cartridge, estimated ΔE information, estimated expiration date based on estimated initial efficacy value and current efficacy value, or if the product has expired based upon the current efficacy value. It is understood that if the consumables and cosmetic substance industry database had determined that the sensed data matched the consumables and cosmetic substance attribute library dataset corresponding to testosterone medicament having specific efficacy values, that the consumer would be alerted to this by the menu panel and therefore prevented from using the wrong medicament. If the consumer determines that he is not pleased with his selection based upon the information provided through the dynamic consumables and cosmetic substance menu panel, he can return to the previous screen and choose another option or select another cartridge of medicament. Upon determining that an option meets his needs, particularly needs related to the information about ΔE and the efficacy content to be delivered, the consumer can proceed with the option by using the dynamic consumables and cosmetic substance menu panel, such as by selecting “proceed”. The dispensing appliance controller then implements adaptive dispensing parameters that are responsive to: the information it has retrieved from the consumables and cosmetic substance industry database by comparing sensed physical attribute data to the consumables and cosmetic substance attribute library; and the consumer input obtained through the dynamic consumables and cosmetic substance menu panel and through monitoring the consumer's blood. These adaptive dispensing parameters, also referred to herein as adaptive dispensing sequence, assure that the consumer will be provided with an adaptively delivered insulin medicament that meets his needs, particularly his needs related to residual efficacy content of the adaptively delivered insulin medicament.

In one example of a consumer using the above described insulin pump, the consumer inserts a cartridge of insulin into the pump. Using its attribute sensors to sense the medicament and communicating with the consumables and cosmetic substance industry database, it is determined that the sensed data matches the consumables and cosmetic substance attribute library dataset corresponding to porcine derived insulin medicament having a particular residual efficacy value. In this case, the residual efficacy value corresponds to 95% of the USP initial efficacy values for porcine derived injectable insulin. The consumer is notified of this information. Thereafter, the insulin pump controller can acquire input from the consumer by providing the options “Bolus”, which provides the consumer with the ability to input a desired dose that will be immediately dispensed, or “Baseline”, wherein the consumer input comprises the input obtained through monitoring his blood sugar and other relevant blood levels. The consumer selects “Baseline” and the controller notifies the consumer when the appropriate monitoring probe is in place. The controller then creates, or retrieves from the consumables and cosmetic substance industry database, adaptive dispensing parameters that are responsive to: the current residual efficacy value information retrieved from the consumables and cosmetic substance industry database using the consumables and cosmetic substance attribute library; and the consumer input obtained through monitoring the consumer's blood. These adaptive dispensing parameters, also referred to herein as adaptive dispensing sequence, are then automatically implemented by the controller to operate the insulin pump.

On another day, the consumer using the above described insulin pump is alerted by the pump that the current cartridge of medicament is empty. He is not able to replace the cartridge for a couple of hours, at which time he inserts a new cartridge of insulin into the pump. Using its attribute sensors to sense the medicament and communicating with the consumables and cosmetic substance industry database, it is determined that the sensed data matches the consumables and cosmetic substance attribute library dataset corresponding to porcine derived insulin medicament having a residual efficacy value equal to 90% of the USP initial efficacy values for porcine derived injectable insulin. The consumer is notified of this information. Thereafter, the insulin pump controller can acquire input from the consumer by providing the options “Bolus”, which provides the consumer with the ability to input a desired dose that will be immediately dispensed, or “Baseline”, wherein the consumer input comprises the input obtained through monitoring his blood sugar and other relevant blood levels. Because of the length of time the consumer has been without insulin, he selects “Bolus” and enters a desired amount of efficacy content to be delivered immediately. The controller then creates, or retrieves from the consumables and cosmetic substance industry database, an adaptive dispensing sequence responsive to the determined residual efficacy value of the insulin medicament and the consumer's input regarding a desired bolus of efficacy content, and automatically operates the insulin pump to adaptively deliver the bolus. After the bolus, the menu panel again prompts the consumer “Bolus” or “Baseline”. The consumer selects “Baseline” and the controller notifies the consumer when the appropriate monitoring probe is in place. The controller then creates, or retrieves from the consumables and cosmetic substance industry database, an adaptive dispensing sequence that is responsive to the current residual efficacy value and the consumer input obtained through monitoring the consumer's blood. The adaptive dispensing sequence is then automatically implemented by the insulin pump through the controller.

On yet another day, the consumer using the above described insulin pump inserts a cartridge of insulin into the pump. Using its attribute sensors to sense the medicament and communicating with the consumables and cosmetic substance industry database, it is determined that the sensed data matches the consumables and cosmetic substance attribute library dataset corresponding to porcine derived insulin medicament having a residual efficacy value equal to 55% of the USP initial efficacy values for porcine derived injectable insulin. The consumer is not only notified of this information, he is alerted that the insulin medicament inside the cartridge has expired, based upon its current residual efficacy value, because in this example, the standard for minimum acceptable residual efficacy value is 70% of the USP initial efficacy value for porcine derived injectable insulin. The consumer removes the expired cartridge, replaces it with another, and can proceed once the contents are determined to correlate with porcine derived injectable insulin having residual efficacy value≧70% of the USP initial efficacy value for porcine derived insulin.

In an embodiment of the present invention, dispenser 570 is provided without controller 530 and consumables and cosmetic substance attribute sensors 591, however it is provided in a format to be compatible with controller 530 and consumables and cosmetic substance attribute sensors 591. Such a dispenser is also referred to herein as an information and sensing capable dispenser. In contrast, traditional dispensers, also referred to herein as dumb dispensers, are not information and sensing capable, are not compatible with controller 530 and nutritional attribute sensors 591, and accordingly will always be dumb dispensers. As information and sensing enabled dispensing systems are increasingly available, dumb dispensers will become increasingly obsolete.

Information and sensing capable dispensers may be provided in a variety of configurations known to those skilled in the art, and the examples offered herein are for purposed of illustration and not intended to be limiting in any way. In one example of an information and sensing capable dispenser, it is provided with traditional functionality, that is, it will interact with consumables and cosmetic substances in a traditional fashion. However, the information and sensing capable dispenser is compatible with separately available controller 530 and consumables and cosmetic substance attribute sensors 591, such that at any time during or after the manufacture and sale of the information and sensing capable dispenser, controller 530 and consumables and cosmetic substance attribute sensors 591 may be coupled with the information and sensing capable dispenser to enable the full functionality and benefit of dispensing module 500. Information and sensing capable dispensers provide appliance manufacturers and consumers great flexibility, and will not become obsolete like dumb dispensers.

The coupling of controller 530 and nutritional attribute sensors 591 to the information and sensing capable dispenser may take any physical and/or communication format known to those skilled in the art. These may include, but are not limited to: an information and sensing capable dispenser provided with Bluetooth, or other wireless near-field communication capability, to communicate with a communication-compatible controller 530, wherein consumables and cosmetic substance attribute sensors 591 are coupled with, or in communication with, controller 530. The controller 530 may be any of a completely separate unit, an externally attachable unit, and an internally placed unit, while portions of the consumables and cosmetic substance attribute sensors may be positioned in proximity to, on, or within the dispenser 570, such as in ports or windows provided with the information and sensing capable dispenser; an information and sensing capable dispenser provided with a USB port, or other electrical communication capability, to communicate with a communication-compatible controller 530, wherein consumables and cosmetic substance attribute sensors 591 are coupled with, or in communication with, controller 530. The controller 530 may be any of a completely separate unit, an externally attachable unit, and an internally placed unit, while portions of the consumables and cosmetic substance attribute sensors may be positioned in proximity to, on, or within the information and sensing capable dispenser, such as in ports or windows provided with the information and sensing capable dispenser; an information and sensing capable dispenser provided with a fiber optic port, or other optical communication capability, to communicate with a communication-compatible controller 530, wherein consumables and cosmetic substance attribute sensors 591 are coupled with, or in communication with, controller 530. The controller 530 may be any of a completely separate unit, an externally attachable unit, and an internally placed unit, while portions of the consumables and cosmetic substance attribute sensors may be positioned in proximity to, on, or within the information and sensing capable dispenser, such as in ports or windows provided with the information and sensing capable dispenser; or an information and sensing capable dispenser provided with WiFi, or other wireless communication capability, to communicate with a WiFi compatible controller 530, wherein consumables and cosmetic substance attribute sensors 591 are coupled with, or in communication with, controller 530. The controller 530 may be any of a completely separate unit, an externally attachable unit, and an internally placed unit, while portions of the consumables and cosmetic substance attribute sensors may be positioned in proximity to, on, or within the dispenser 570, such as in ports or windows provided with the information and sensing capable dispenser. It is understood that the controller 530 may be provided with its own consumer interface, may communicate and be operated through the consumer interface provided with the information and sensing capable dispenser, or a combination of both.

It is understood that consumables and cosmetic substance attribute sensors can beneficially be provided with, or combined with, other consumables and cosmetic substance modules, including transformation, preservation, and consumer modules. For example, the consumables and cosmetic substance attribute sensors could be provided with the local storage environments, containers, and coupons described herein. Consumables and cosmetic substance attribute sensors, or at least a portion of the consumables and cosmetic substance attribute sensor, could be provided with or incorporated into the package of any pre-packaged consumables and cosmetic substance, such that a consumer may interrogate the package without disrupting its integrity to obtain information related to an efficacy value of the consumables and cosmetic substance contained therein. Further, consumables and cosmetic substance attribute sensors, or at least a portion of the consumables and cosmetic substance attribute sensor, could be provided with, coupled to, or incorporated into smartphones. This would enable a wide array of users and scenarios wherein consumables and cosmetic substances can be identified and their current efficacy value can be determined.

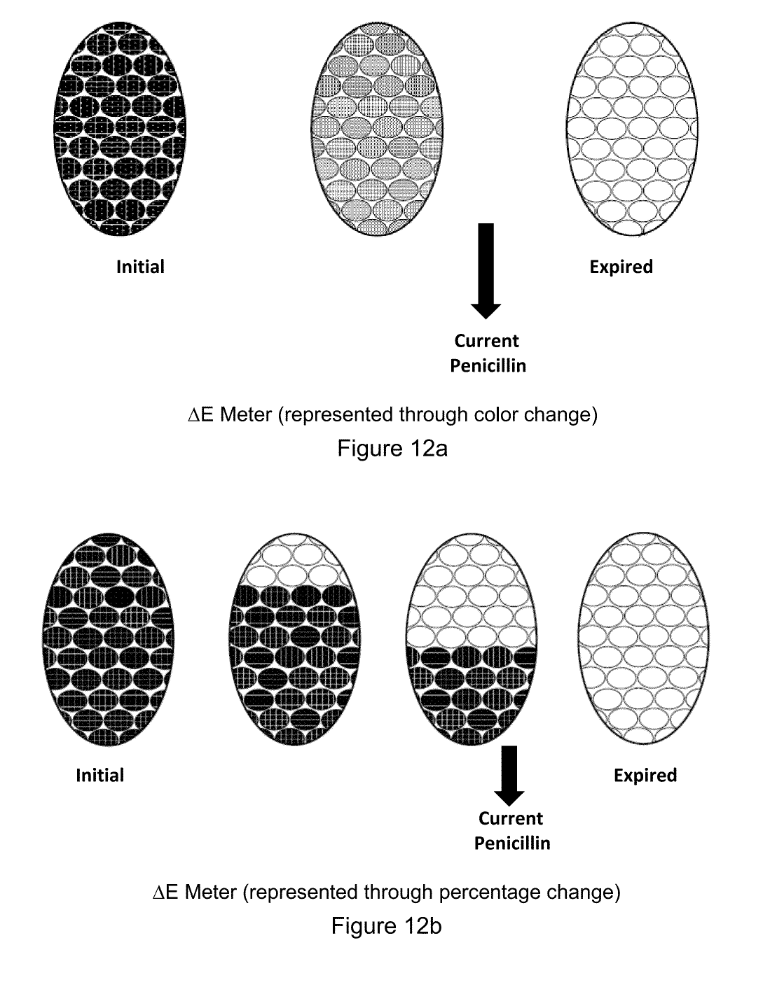

FIGS. 12a and 12b are example formats, provided for illustrative purposes only and not intended to be limiting in any way, showing how a ΔE, and related residual and initial efficacy values, may be expressed. The pill shown in FIGS. 12a and 12b represents an efficacy value associated with a consumables and cosmetic substance. While any object may be chosen to represent an efficacy value, in a preferred embodiment, the chosen object corresponds to a logo, symbol, mascot, or other object associated with a Brand. Such a Brand might be associated with, and provided to enhance and broaden, a consumables and cosmetic substance information system. Alternatively, such a Brand might be associated with a Measurement, Inspection, Engineering, Regulatory, Certification, or other published standard. The object chosen to represent an efficacy value is also referred to herein as a ΔE meter. The ΔE meter shown in FIGS. 12a and 12b, provided for illustrative purposes only and not intended to be limiting in any way, is a pill, wherein the pill corresponds to the logo of the provider of a consumables and cosmetic substance information system.

In FIG. 12a, the ΔE meter communicates various items regarding an efficacy value of a corresponding consumables and cosmetic substance, for the purpose of this example, a value expressing the concentration of Penicillin in a bottle of antibiotic suspension provided with a dynamic information identifier. In an example, a consumer desiring information regarding Penicillin values of the antibiotic suspension can use the consumables and cosmetic substance reader of a dispensing system, or alternatively, of a local storage environment or container, to scan the dynamic information identifier and determine the desired information. In this example, the information is presented to the consumer on a menu panel in the form of the ΔE meter shown in FIG. 12a. The ΔE meter of this example communicates symbolically through color, and color changes, the initial Penicillin value, the current Penicillin value, and an expired Penicillin value. The values may be shown as relative values without units of measure, as shown, or may further be provided with actual units of measure. In this example, the consumer is provided with a conceptual indicator regarding how much the Penicillin value has degraded relative to its initial value and where its current value is relative to the expiration value.

In FIG. 12b, a ΔE meter communicates various items regarding a nutritional value of a corresponding consumables and cosmetic substance, for the purpose of this example, the Penicillin value of a bottle of antibiotic suspension provided with a dynamic information identifier. A consumer desiring information regarding Penicillin levels of the antibiotic suspension can use the consumables and cosmetic substance reader of a dispensing system, or alternatively, of a local storage environment or container, to scan the dynamic information identifier and determine the desired information. In this example, the information is presented to the consumer on a menu panel in the form of the ΔE meter shown in FIG. 12b. The ΔE meter of this example communicates efficacy symbolically through percent fill-level and percent fill-level changes, showing the initial Penicillin value, the current Penicillin value, and an expired Penicillin value. The values may be shown as relative values without units of measure, as shown, or may further be provided with actual units of measure. In this example, the consumer is provided with a conceptual indicator regarding how much the Penicillin value has degraded relative to its initial value and where its current value is relative to the expiration value.

It is understood that ΔE meters may take many forms and communicate various messages regarding a ΔE value or a corresponding residual efficacy value of consumables and cosmetic substances, and the examples provided above are for illustrative purposes and not intended to be limiting in any way. It is further understood that ΔE meters may be utilized to communicate ΔE values and residual efficacy values determined or estimated in any fashion. In preferred embodiments, the ΔE value or the residual efficacy value are determined utilizing the consumables and cosmetic substance information systems disclosed herein, including systems utilizing dynamic information identifiers and corresponding consumables and cosmetic substance database, systems utilizing efficacy attribute sensors and corresponding consumables and cosmetic substance attribute library, or a combination of both.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. Any claims intended to be treated under 35 U.S.C. §112, ¶ 6 will begin with the words “means for.” Accordingly, the applicant reserves the right to add additional claims after filing the application to pursue such additional claim forms for other aspects of the invention.

1. An adaptive dispensing system for consumables and cosmetic substances comprising:
an adaptive controller for detecting a dynamic information identifier provided with a consumables and cosmetic substance and a consumer's input regarding the consumables and cosmetic substance; and
a database with information referenced to the dynamic information identifier and related to a ΔE of the consumables and cosmetic substance; and
an input panel for acquiring the consumer's input and communicating a dynamic efficacy value table responsive to the ΔE and the consumer's input.

2. An adaptive dispensing system for consumables and cosmetic substances according to claim 1, wherein
the controller provides an adaptive dispensing sequence responsive to the ΔE and the consumer's input through the input panel.

3. An adaptive dispensing system for consumables and cosmetic substances according to claim 1, wherein
the controller automatically implements an adaptive dispensing sequence responsive to the ΔE and the consumer's input.

4. An adaptive dispensing system for consumables and cosmetic substances comprising:
an adaptive controller for detecting values of physical attributes of a consumables and cosmetic substance and a consumer's input regarding the consumables and cosmetic substance; and
sensors for currently sensing the values of physical attributes of the consumables and cosmetic substance; and
a library comprising datasets of values of physical attributes referenced to known consumables and cosmetic substances at known efficacy states, wherein
the currently sensed values are compared with the datasets to determine a matching dataset; and
an input panel for acquiring the consumer's input and communicating a dynamic efficacy value table responsive to the matching dataset.

5. An adaptive dispensing system for consumables and cosmetic substances according to claim 4, wherein
the controller provides an adaptive dispensing sequence responsive to the matching dataset and the consumer's input through the input panel.

6. An adaptive dispensing system for consumables and cosmetic substances according to claim 4 wherein
the controller automatically implements an adaptive dispensing sequence responsive to the matching dataset and the consumer's input.

7. A dynamic local storage system for consumables and cosmetic substances comprising:
an adaptive controller for detecting a dynamic information identifier provided with a consumables and cosmetic substance and a condition related the consumables and cosmetic substance; and
a database with information referenced to the dynamic information identifier and related to a ΔE of the consumables and cosmetic substance; and
a menu panel for communicating the ΔE to a consumer.

8. A dynamic local storage system for consumables and cosmetic substances according to claim 7, wherein
the menu panel communicates the ΔE information through a dynamic efficacy value table.

9. A dynamic local storage system for consumables and cosmetic substances according to claim 7, wherein
the controller is part of a local storage environment.

10. A dynamic local storage system for consumables and cosmetic substances according to claim 7, wherein
the controller is part of a local storage container.

11. A dynamic local storage system for consumables and cosmetic substances according to claim 7, wherein
the controller is part of a local storage coupon.

12. A dynamic local storage system for consumables and cosmetic substances according to claim 11, wherein
the local storage coupon is placed with, within, or in proximity to at least one of a local storage environment and a local storage container.

13. A dynamic local storage system for consumables and cosmetic substances according to claim 7, wherein
the menu panel is part of at least one of a local storage environment, a local storage container, a local storage coupon, a dispenser, and a smartphone.

14. A dynamic local storage system for consumables and cosmetic substances according to claim 7, wherein
the controller adapts the operation of a local storage environment or local storage container responsive to the ΔE.
